(19) United States
(12) Patent Application Publication
(10) Pub. No.: US 2017/0083341 A1
(43) Pub. Date: Mar. 23, 2017

(54) SEGMENTED INSTRUCTION BLOCK

(71) Applicant: Microsoft Technology Licensing, LLC, Redmond, WA (US)

(72) Inventors: Douglas C. Burger, Bellevue, WA (US); Aaron L. Smith, Seattle, WA (US)

(73) Assignee: MICROSOFT TECHNOLOGY LICENSING, LLC, Redmond, WA (US)

(21) Appl. No.: 14/942,345

(22) Filed: Nov. 16, 2015

Related U.S. Application Data
(60) Provisional application No. 62/221,003, filed on Sep. 19, 2015.

(51) Int. Cl. G06F 9/38; G06F 9/32

(52) U.S. Cl. CPC G06F 9/3822; G06F 9/32; G06F 9/3802

(57) ABSTRACT

Systems and methods are disclosed for fetching and decoding instructions in block-based processor architectures. In one example of the disclosed technology, a block-based processor core can be used for executing an instruction block. The instruction block can include an instruction header and one or more instructions. The block-based processor core can include header decode logic and fetch logic that are in communication with each other. The header decode logic can be configured to decode the instruction block header to determine starting positions of a plurality of sub-blocks within the instruction block. The fetch logic can be configured to initiate parallel fetch and decode operations for the plurality of sub-blocks.

### CROSS-REFERENCE TO RELATED APPLICATIONS

This application claims the benefit of U.S. Provisional Application No. 62/221,003, entitled “BLOCK-BASED PROCESSORS,” filed Sep. 19, 2015, the entire disclosure of which is incorporated herein by reference in its entirety.

### BACKGROUND

Microprocessors have benefitted from continuing gains in transistor count, integrated circuit cost, manufacturing capital, clock frequency, and energy efficiency due to continued transistor scaling predicted by Moore's law, with little change in associated processor Instruction Set Architectures (ISAs). However, the benefits realized from photolithographic scaling, which drove the semiconductor industry over the last 40 years, are slowing or even reversing. Reduced Instruction Set Computing (RISC) architectures have been the dominant paradigm in processor design for many years. Out-of-order superscalar implementations have not exhibited sustained improvement in area or performance. Accordingly, there is ample opportunity for improvements in processor ISAs to extend performance improvements.

### SUMMARY

Methods, apparatus, and computer-readable storage devices are disclosed for using a segmented instruction block of a block-based processor instruction set architecture (BB-ISA). The described techniques and tools can potentially improve processor performance and can be implemented separately, or in various combinations with each other. As will be described more fully below, the described techniques and tools can be implemented in a digital signal processor, microprocessor, application-specific integrated circuit (ASIC), a soft processor (e.g., a microprocessor core implemented in a field programmable gate array (FPGA) using reconfigurable logic), programmable logic, or other suitable logic circuitry. As will be readily apparent to one of ordinary skill in the art, the disclosed technology can be implemented in various computing platforms, including, but not limited to, servers, mainframes, cellphones, smartphones, PDAs, handheld devices, handheld computers, touch screen tablet devices, tablet computers, wearable computers, and laptop computers.

In some examples of the disclosed technology, a block-based processor core can be used for executing an instruction block. The instruction block can include an instruction header and one or more instructions. The block-based processor core can include header decode logic and fetch logic that are in communication with each other. The header decode logic can be configured to decode the instruction block header to determine starting positions of a plurality of sub-blocks within the instruction block. The fetch logic can be configured to initiate parallel fetch and decode operations for the plurality of sub-blocks.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. The foregoing and other objects, features, and advantages of the disclosed subject matter will become more apparent from the following detailed description, which proceeds with reference to the accompanying figures.

### BRIEF DESCRIPTION OF THE DRAWINGS

FIG. 1 illustrates a block-based processor including multiple processor cores, as can be used in some examples of the disclosed technology.

FIG. 2 illustrates a block-based processor core, as can be used in some examples of the disclosed technology.

FIG. 3 illustrates a number of instruction blocks, according to certain examples of disclosed technology.

FIG. 4 illustrates portions of source code and respective instruction blocks.

FIG. 5 illustrates block-based processor headers and instructions, as can be used in some examples of the disclosed technology.

FIG. 6 is a flowchart illustrating an example of a progression of states of a processor core of a block-based processor.

FIG. 7 is a flowchart illustrating an example method of compiling a program for a block-based processor, as can be performed in some examples of the disclosed technology.

FIGS. 8-9 are examples of different arrangements of instructions within instruction blocks targeted to a block-based processor.

FIGS. 10-11 are examples of different configurations of fetch and decode logic of a block-based processor core.

FIG. 12 is a flowchart illustrating an example method of fetching and decoding instructions in a block-based processor core, as can be performed in some examples of the disclosed technology.

FIG. 13 is a block diagram illustrating a suitable computing environment for implementing some embodiments of the disclosed technology.

### DETAILED DESCRIPTION

### I. General Considerations

This disclosure is set forth in the context of representative embodiments that are not intended to be limiting in any way.

As used in this application the singular forms “a,” “an,” and “the” include the plural forms unless the context clearly dictates otherwise. Additionally, the term “includes” means “comprises.” Further, the term “coupled” encompasses mechanical, electrical, magnetic, optical, as well as other practical ways of coupling or linking items together, and does not exclude the presence of intermediate elements between the coupled items. Furthermore, as used herein, the term “and/or” means any one item or combination of items in the phrase.

The systems, methods, and apparatus described herein should not be construed as being limiting in any way. Instead, this disclosure is directed toward all novel and non- obvious features and aspects of the various disclosed embodiments, alone and in various combinations and subcombinations with one another. The disclosed systems, methods, and apparatus are not limited to any specific aspect or feature or combinations thereof, nor do the disclosed things and methods require that any one or more specific advantages be present or problems be solved. Furthermore, any features or aspects of the disclosed embodiments can be used in various combinations and subcombinations with one another.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed things and methods can be used in conjunction with other things and methods. Additionally, the description sometimes uses terms like “produce,” “generate,” “display,” “receive,” “emit,” “verify,” “execute,” and “initiate” to describe the disclosed methods. These terms are high- level descriptions of the actual operations that are performed. The actual operations that correspond to these terms will vary depending on the particular implementation and are readily discernible by one of ordinary skill in the art.

Theories of operation, scientific principles, or other theoretical descriptions presented herein in reference to the apparatus or methods of this disclosure have been provided for the purposes of better understanding and are not intended to be limiting in scope. The apparatus and methods in the appended claims are not limited to those apparatus and methods that function in the manner described by such theories of operation.

Any of the disclosed methods can be implemented as computer-executable instructions stored on one or more computer-readable media (e.g., computer-readable media, such as one or more optical media discs, volatile memory components (such as DRAM or SRAM), or nonvolatile memory components (such as hard drives)) and executed on a computer (e.g., any commercially available computer, including smart phones or other mobile devices that include computing hardware). Any of the computer-executable instructions for implementing the disclosed techniques, as well as any data created and used during implementation of the disclosed embodiments, can be stored on one or more computer-readable media (e.g., computer-readable storage media). The computer-executable instructions can be part of, for example, a dedicated software application or a software application that is accessed or downloaded via a web browser or other software application (such as a remote computing application). Such software can be executed, for example, on a single local computer (e.g., as an agent executing on any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C, C++, Java, or any other suitable programming language. Likewise, the disclosed technology is not limited to any particular computer or type of hardware. Certain details of suitable computers and hardware are well-known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

### II. Introduction to the Disclosed Technologies

Superscalar out-of-order microarchitectures employ substantial circuit resources to rename registers, schedule instructions in dataflow order, clean up after miss-speculation, and retire results in-order for precise exceptions. This includes expensive energy-consuming circuits, such as deep, many-ported register files, many-ported content-accessible memories (CAMs) for dataflow instruction scheduling wakeup, and many-wide bus multiplexers and bypass networks, all of which are resource intensive. For example, FPGA-based implementations of multi-read, multi-write RAMs typically require a mix of replication, multi-cycle operation, clock doubling, bank interleaving, live-value tables, and other expensive techniques.

The disclosed technologies can realize energy efficiency and/or performance enhancement through application of techniques including high instruction-level parallelism (ILP), out-of-order (OoO), superscalar execution, while avoiding substantial complexity and overhead in both processor hardware and associated software. In some examples of the disclosed technology, a block-based processor comprising multiple processor cores uses an Explicit Data Graph Execution (EDGE) ISA designed for area- and energy-efficient, high-ILP execution. In some examples, use of EDGE architectures and associated compilers finesses away much of the register renaming, CAMs, and complexity. In some examples, the respective cores of the block-based processor can store or cache fetched and decoded instructions that may be repeatedly executed, and the fetched and decoded instructions can be reused to potentially achieve reduced power and/or increased performance.

In certain examples of the disclosed technology, an EDGE ISA can eliminate the need for one or more complex architectural features, including register renaming, dataflow analysis, misspeculation recovery, and in-order retirement while supporting mainstream programming languages such as C and C++. In certain examples of the disclosed technology, a block-based processor executes a plurality of two or more instructions as an atomic block. Block-based instructions can be used to express semantics of program data flow and/or instruction flow in a more explicit fashion, allowing for improved compiler and processor performance. In certain examples of the disclosed technology, an explicit data graph execution instruction set architecture (EDGE ISA) includes information about program control flow that can be used to improve detection of improper control flow instructions, thereby increasing performance, saving memory resources, and/or and saving energy.

In some examples of the disclosed technology, instructions organized within instruction blocks are fetched, executed, and committed atomically. Instructions inside blocks execute in dataflow order, which reduces or eliminates using register renaming and provides power-efficient OoO execution. A compiler can be used to explicitly encode data dependencies through the ISA, reducing or eliminating burdening processor core control logic from rediscovering dependencies at runtime. Using predicated execution, intra-block branches can be converted to dataflow instructions, and dependencies, other than memory dependencies, can be limited to direct data dependencies. Disclosed target form encoding techniques allow instructions within a block to communicate their operands directly via operand buffers, reducing accesses to a power-hungry, multi-ported physical register files.

Between instruction blocks, instructions can communicate using memory and registers. Thus, by utilizing a hybrid dataflow execution model, EDGE architectures can still support imperative programming languages and sequential memory semantics, but desirably also enjoy the benefits of out-of-order execution with near in-order power efficiency and complexity.

As will be readily understood to one of ordinary skill in the relevant art, a spectrum of implementations of the disclosed technology are possible with various area, performance, and power tradeoffs.

### III. Example Block-Based Processor

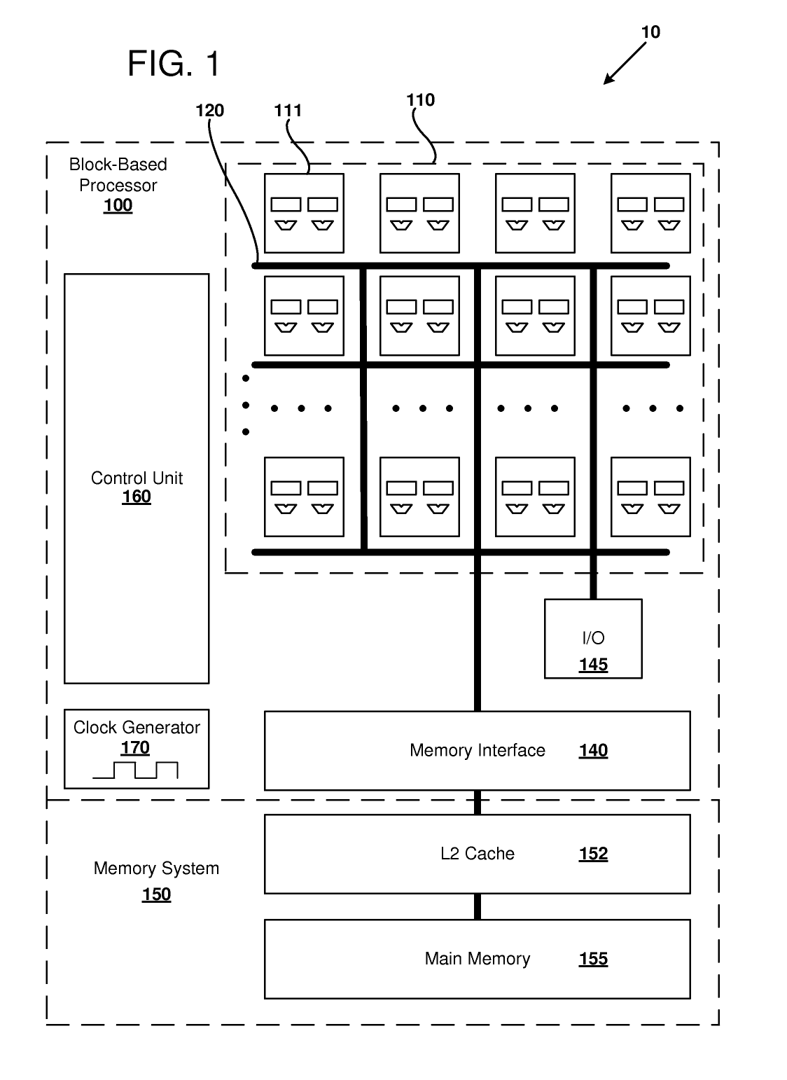

FIG. 1 is a block diagram 10 of a block-based processor 100 as can be implemented in some examples of the disclosed technology. The processor 100 is configured to execute atomic blocks of instructions according to an instruction set architecture (ISA), which describes a number of aspects of processor operation, including a register model, a number of defined operations performed by block-based instructions, a memory model, interrupts, and other architectural features. The block-based processor includes a plurality of processing cores 110, including a processor core 111.

As shown in FIG. 1, the processor cores are connected to each other via core interconnect 120. The core interconnect 120 carries data and control signals between individual ones of the cores 110, a memory interface 140, and an input/output (I/O) interface 145. The core interconnect 120 can transmit and receive signals using electrical, optical, magnetic, or other suitable communication technology and can provide communication connections arranged according to a number of different topologies, depending on a particular desired configuration. For example, the core interconnect 120 can have a crossbar, a bus, a point-to-point bus, or other suitable topology. In some examples, any one of the cores 110 can be connected to any of the other cores, while in other examples, some cores are only connected to a subset of the other cores. For example, each core may only be connected to a nearest 4, 8, or 20 neighboring cores. The core interconnect 120 can be used to transmit input/output data to and from the cores, as well as transmit control signals and other information signals to and from the cores. For example, each of the cores 110 can receive and transmit semaphores that indicate the execution status of instructions currently being executed by each of the respective cores. In some examples, the core interconnect 120 is implemented as wires connecting the cores 110, and memory system, while in other examples, the core interconnect can include circuitry for multiplexing data signals on the interconnect wire(s), switch and/or routing components, including active signal drivers and repeaters, or other suitable circuitry. In some examples of the disclosed technology, signals transmitted within and to/from the processor 100 are not limited to full swing electrical digital signals, but the processor can be configured to include differential signals, pulsed signals, or other suitable signals for transmitting data and control signals.

In the example of FIG. 1, the memory interface 140 of the processor includes interface logic that is used to connect to additional memory, for example, memory located on another integrated circuit besides the processor 100. As shown in FIG. 1 an external memory system 150 includes an L2 cache 152 and main memory 155. In some examples the L2 cache can be implemented using static RAM (SRAM) and the main memory 155 can be implemented using dynamic RAM (DRAM). In some examples the memory system 150 is included on the same integrated circuit as the other components of the processor 100. In some examples, the memory interface 140 includes a direct memory access (DMA) controller allowing transfer of blocks of data in memory without using register file(s) and/or the processor 100. In some examples, the memory interface manages allocation of virtual memory, expanding the available main memory 155.

The I/O interface 145 includes circuitry for receiving and sending input and output signals to other components, such as hardware interrupts, system control signals, peripheral interfaces, co-processor control and/or data signals (e.g., signals for a graphics processing unit, floating point coprocessor, physics processing unit, digital signal processor, or other co-processing components), clock signals, semaphores, or other suitable I/O signals. The I/O signals may be synchronous or asynchronous. In some examples, all or a portion of the I/O interface is implemented using memory-mapped I/O techniques in conjunction with the memory interface 140.

The block-based processor 100 can also include a control unit 160. The control unit 160 supervises operation of the processor 100. Operations that can be performed by the control unit 160 can include allocation and de-allocation of cores for performing instruction processing, control of input data and output data between any of the cores, register files, the memory interface 140, and/or the I/O interface 145, modification of execution flow, and verifying target location(s) of branch instructions, instruction headers, and other changes in control flow. The control unit 160 can also process hardware interrupts, and control reading and writing of special system registers, for example the program counter stored in one or more register file(s). In some examples of the disclosed technology, the control unit 160 is at least partially implemented using one or more of the processing cores 110, while in other examples, the control unit 160 is implemented using a non-block-based processing core (e.g., a general-purpose RISC processing core coupled to memory). In some examples, the control unit 160 is implemented at least in part using one or more of: hardwired finite state machines, programmable microcode, programmable gate arrays, or other suitable control circuits. In alternative examples, control unit functionality can be performed by one or more of the cores 110.

The control unit 160 includes a scheduler that is used to allocate instruction blocks to the processor cores 110. As used herein, scheduler allocation refers to hardware for directing operation of instruction blocks, including initiating instruction block mapping, fetching, decoding, execution, committing, aborting, idling, and refreshing an instruction block. In some examples, the hardware receives signals generated using computer-executable instructions to direct operation of the instruction scheduler. Processor cores 110 are assigned to instruction blocks during instruction block mapping. The recited stages of instruction operation are for illustrative purposes, and in some examples of the disclosed technology, certain operations can be combined, omitted, separated into multiple operations, or additional operations added.

The block-based processor 100 also includes a clock generator 170, which distributes one or more clock signals to various components within the processor (e.g., the cores 110, interconnect 120, memory interface 140, and I/O interface 145). In some examples of the disclosed technology, all of the components share a common clock, while in other examples different components use a different clock, for example, a clock signal having differing clock frequencies. In some examples, a portion of the clock is gated to allow power savings when some of the processor components are not in use. In some examples, the clock signals are generated using a phase-locked loop (PLL) to generate a signal of fixed, constant frequency and duty cycle. Circuitry that receives the clock signals can be triggered on a single edge (e.g., a rising edge) while in other examples, at least some of the receiving circuitry is triggered by rising and falling clock edges. In some examples, the clock signal can be transmitted optically or wirelessly.

### IV. Example Block-Based Processor Core

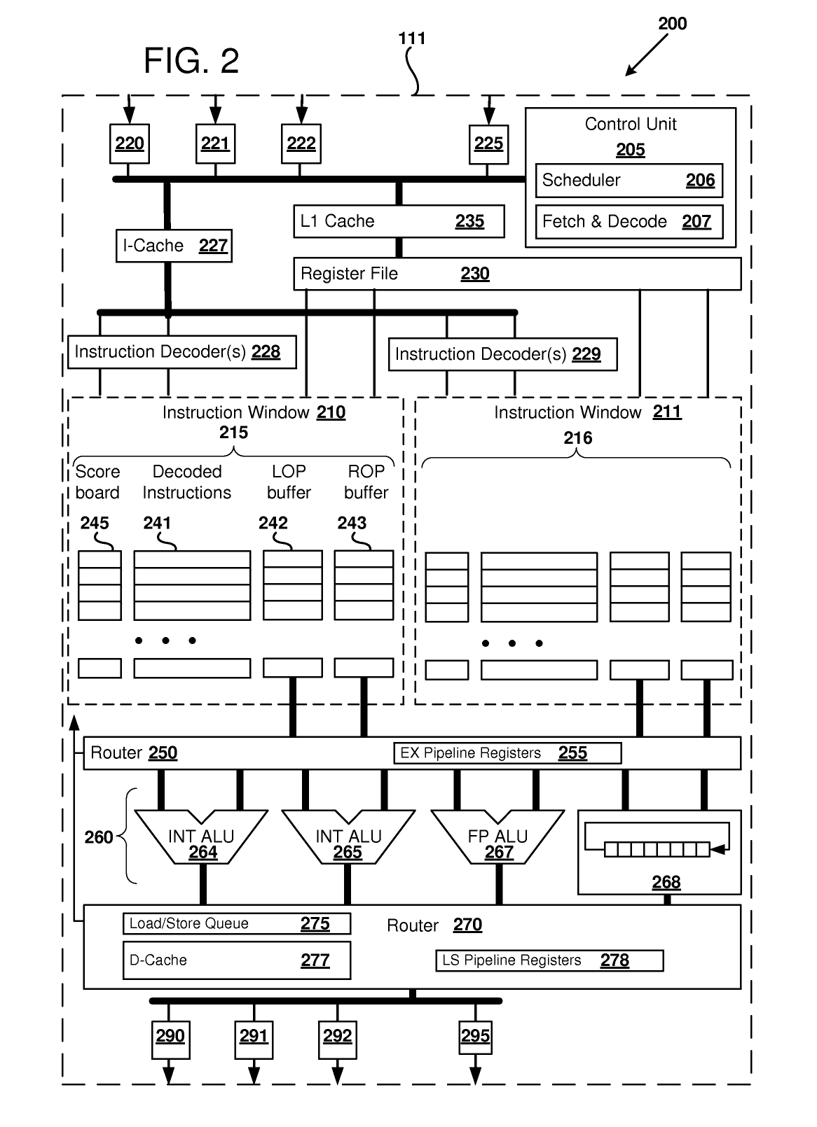

FIG. 2 is a block diagram 200 further detailing an example microarchitecture for the block-based processor 100, and in particular, an instance of one of the block-based processor cores (processor core 111), as can be used in certain examples of the disclosed technology. For ease of explanation, the exemplary block-based processor core 111 is illustrated with five stages: instruction fetch (IF), decode (DC), operand fetch, execute (EX), and memory/data access (LS). However, it will be readily understood by one of ordinary skill in the relevant art that modifications to the illustrated microarchitecture, such as adding/removing stages, adding/removing units that perform operations, and other implementation details can be modified to suit a particular application for a block-based processor.

As shown in FIG. 2, the example processor core 111 includes two instruction windows 210 and 211, each of which can be configured to execute an instruction block. In other examples, different numbers of instruction windows are possible, such as one, four, eight, or other number of instruction windows. In some examples of the disclosed technology, an instruction block is an atomic collection of block-based-processor instructions that includes an instruction block header and a plurality of one or more instructions. As will be discussed further below, the instruction block header includes information describing the arrangement or organization of the instruction block and information that can be used to further define semantics of one or more of the plurality of instructions within the instruction block. Depending on the particular ISA and processor hardware used, the instruction block header can also be used during execution of the instructions, and to improve performance of executing an instruction block by, for example, allowing for early fetching of instructions and/or data, improved branch prediction, speculative execution, improved energy efficiency, and improved code compactness. The instructions of the instruction block can be dataflow instructions that explicitly encode relationships between producer-consumer instructions of the instruction block.

The processor core 111 includes a control unit 205, which decodes information about the instruction block using a header decoder 207 and generates control signals to regulate core operation and schedules the flow of instructions within the core 111 using an instruction scheduler 206. In particular, the control unit 205 can sequence the instructions of one or more instruction blocks executing on one or more instruction windows (210, 211) of the processor core 111. For example, each of the instructions can be sequenced through the instruction fetch, decode, operand fetch, execute, and memory/data access stages so that the instructions of an instruction block can be pipelined and executed in parallel. As will be discussed further below, the instruction block can be divided into one or more segments or sub-blocks to potentially increase the opportunities to parallelize operations of the core 111. The instruction header can encode location information for each of the segments so that instructions for each segment can be fetched and decoded in parallel. Operations occurring in parallel are operations that occur concurrently. As one example, two decode operations can occur in parallel when each of the decode operations is performed by a different respective decoder during the same clock cycle.

Operations that can be performed by the control unit 205 and/or instruction scheduler 206 can include allocation and de-allocation of cores for performing instruction processing, control of input data and output data between any of the cores, register files, the memory interface 140, and/or the I/O interface 145. The control unit 205 can also process hardware interrupts, and control reading and writing of special system registers, for example the program counter stored in one or more register file(s). In other examples of the disclosed technology, the control unit 205, instruction scheduler 206, and/or fetch and decode logic 207 are implemented using a non-block-based processing core (e.g., a general-purpose RISC processing core coupled to memory). In some examples, the control unit 205, instruction scheduler 206, and/or fetch and decode logic 207 are implemented at least in part using one or more of: hardwired finite state machines, programmable microcode, programmable gate arrays, or other suitable control circuits. The fetch and decode logic 207 can fetch and decode instruction headers and instructions within an instruction block.

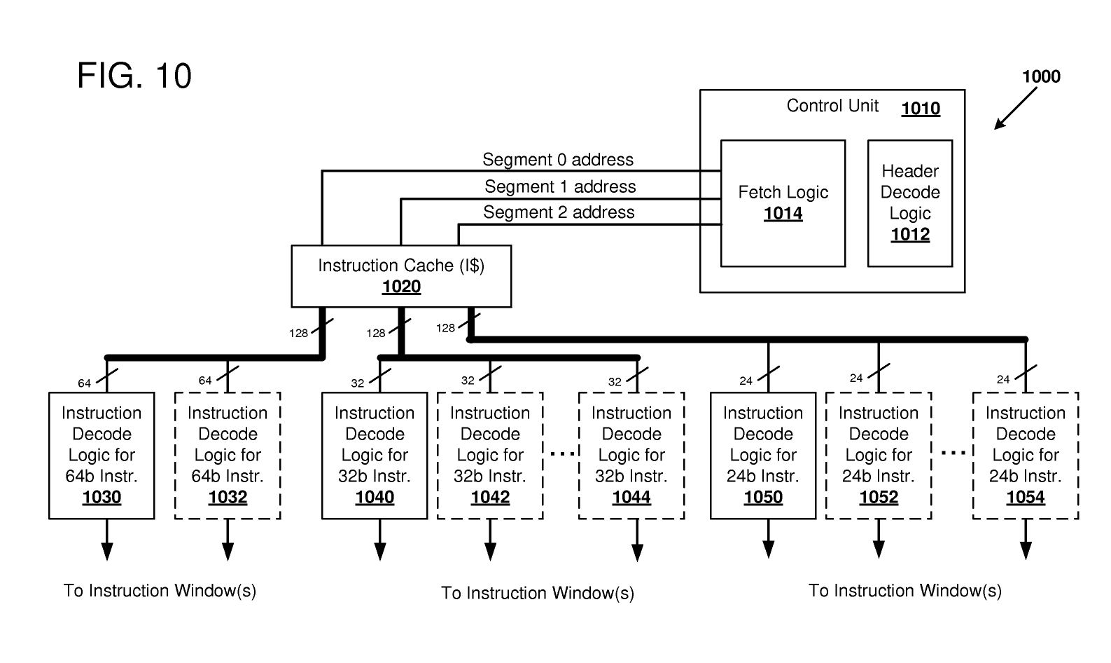

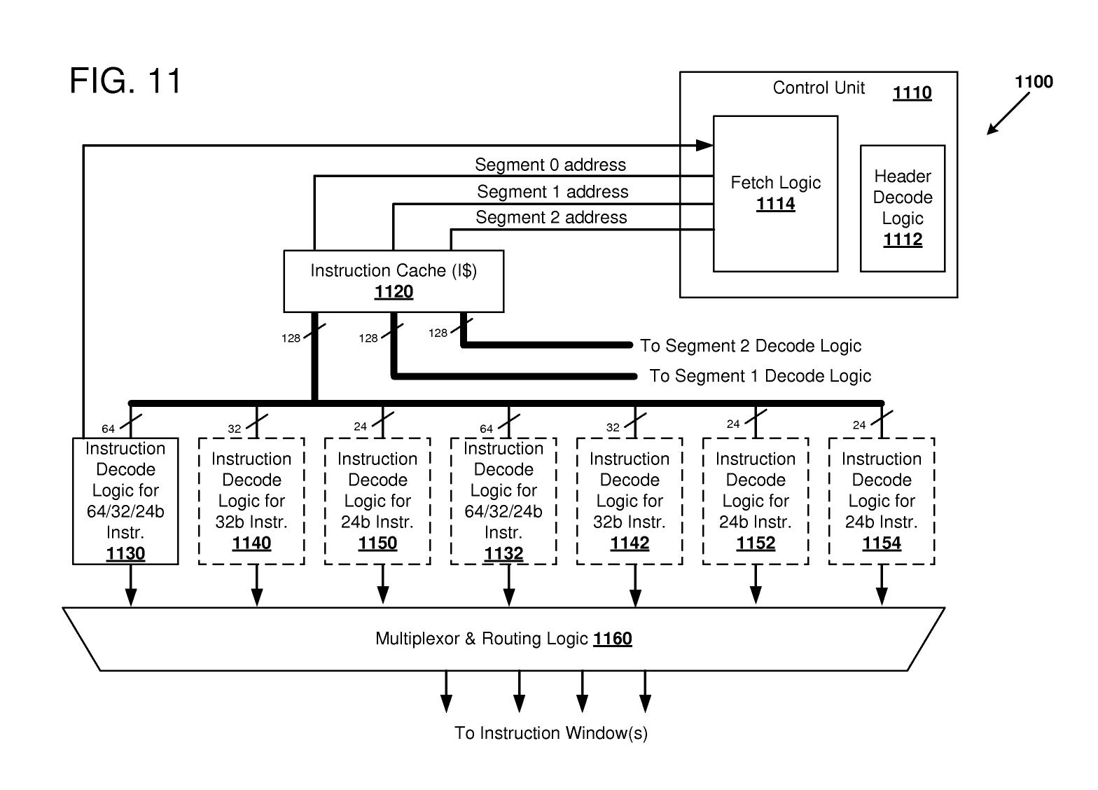

Each of the instruction windows 210 and 211 can receive instructions and data from one or more of input ports 220, 221, and 222 which connect to an interconnect bus and instruction cache 227, which in turn is connected to the instruction decoders 228 and 229. Additional control signals can also be received on an additional input port 225. Each of the instruction decoders 228 and 229 decodes instructions for an instruction block and stores the decoded instructions within a memory store 215 and 216 located in each respective instruction window 210 and 211. As will be discussed further below (such as in reference to FIGS. 10-11), the respective instruction decoders 228 and 229 can decode one instruction per cycle or multiple instructions in parallel per cycle.

The processor core 111 further includes a register file 230 coupled to an L1 (level one) cache 235. The register file 230 stores data for registers defined in the block-based processor architecture, and can have one or more read ports and one or more write ports. For example, a register file may include two or more write ports for storing data in the register file, as well as having a plurality of read ports for reading data from individual registers within the register file. In some examples, a single instruction window (e.g., instruction window 210) can access only one port of the register file at a time, while in other examples, the instruction window 210 can access one read port and one write port, or can access two or more read ports and/or write ports simultaneously. In some examples, the register file 230 can include 64 registers, each of the registers holding a word of 32 bits of data. (This application will refer to 32-bits of data as a word, unless otherwise specified.) In some examples, some of the registers within the register file 230 may be allocated to special purposes. For example, some of the registers can be dedicated as system registers examples of which include registers storing constant values (e.g., an all zero word), program counter(s) (PC), which indicate the current address of a program thread that is being executed, a physical core number, a logical core number, a core assignment topology, core control flags, a processor topology, or other suitable dedicated purpose. In some examples, there are multiple program counter registers, one or each program counter, to allow for concurrent execution of multiple execution threads across one or more processor cores and/or processors. In some examples, program counters are implemented as designated memory locations instead of as registers in a register file. In some examples, use of the system registers may be restricted by the operating system or other supervisory computer instructions. In some examples, the register file 230 is implemented as an array of flip-flops, while in other examples, the register file can be implemented using latches, SRAM, or other forms of memory storage. The ISA specification for a given processor, for example processor 100, specifies how registers within the register file 230 are defined and used.

In some examples, the processor 100 includes a global register file that is shared by a plurality of the processor cores. In some examples, individual register files associated with a processor core can be combined to form a larger file, statically or dynamically, depending on the processor ISA and configuration.

As shown in FIG. 2, the memory store 215 of the instruction window 210 includes a number of decoded instructions 241, a left operand (LOP) buffer 242, a right operand (ROP) buffer 243, and an instruction scoreboard 245. In some examples of the disclosed technology, each instruction of the instruction block is decomposed into a row of decoded instructions, left and right operands, and scoreboard data, as shown in FIG. 2. The decoded instructions 241 can include partially- or fully-decoded versions of instructions stored as bit-level control signals. The operand buffers 242 and 243 store operands (e.g., register values received from the register file 230, data received from memory, immediate operands coded within an instruction, operands calculated by an earlier-issued instruction, or other operand values) until their respective decoded instructions are ready to execute. Instruction operands are read from the operand buffers 242 and 243, not the register file.

The memory store 216 of the second instruction window 211 stores similar instruction information (decoded instructions, operands, and scoreboard) as the memory store 215, but is not shown in FIG. 2 for the sake of simplicity. Instruction blocks can be executed by the second instruction window 211 concurrently or sequentially with respect to the first instruction window, subject to ISA constraints and as directed by the control unit 205.

In some examples of the disclosed technology, front-end pipeline stages IF and DC can run decoupled from the back-end pipelines stages (IS, EX, LS). In one embodiment, the control unit can fetch and decode two instructions per clock cycle into each of the instruction windows 210 and 211. In alternative embodiments, the control unit can fetch and decode one, four, or another number of instructions per clock cycle into a corresponding number of instruction windows. The control unit 205 provides instruction window dataflow scheduling logic to monitor the ready state of each decoded instruction's inputs (e.g., each respective instruction's predicate(s) and operand(s) using the scoreboard 245. When all of the inputs for a particular decoded instruction are ready, the instruction is ready to issue. The control logic 205 then initiates execution of one or more next instruction(s) (e.g., the lowest numbered ready instruction) each cycle and its decoded instruction and input operands are sent to one or more of functional units 260 for execution. The decoded instruction can also encode a number of ready events. The scheduler in the control logic 205 accepts these and/or events from other sources and updates the ready state of other instructions in the window. Thus execution proceeds, starting with the processor core's 111 ready zero input instructions, instructions that are targeted by the zero input instructions, and so forth.

The decoded instructions 241 need not execute in the same order in which they are arranged within the memory store 215 of the instruction window 210. Rather, the instruction scoreboard 245 is used to track dependencies of the decoded instructions and, when the dependencies have been met, the associated individual decoded instruction is scheduled for execution. For example, a reference to a respective instruction can be pushed onto a ready queue when the dependencies have been met for the respective instruction, and instructions can be scheduled in a first-in first-out (FIFO) order from the ready queue. Information stored in the scoreboard 245 can include, but is not limited to, the associated instruction's execution predicate (such as whether the instruction is waiting for a predicate bit to be calculated and whether the instruction executes if the predicate bit is true or false), availability of operands to the instruction, or other prerequisites required before executing the associated individual instruction.

In one embodiment, the scoreboard 245 can include decoded ready state, which is initialized by the instruction decoder 228, and active ready state, which is initialized by the control unit 205 during execution of the instructions. For example, the decoded ready state can encode whether a respective instruction has been decoded, awaits a predicate and/or some operand(s), perhaps via a broadcast channel, or is immediately ready to issue. The decoded active state can encode whether a respective instruction awaits a predicate and/or some operand(s), is ready to issue, or has already issued. The decoded ready state can cleared on a block reset or a block refresh. Upon branching to a new instruction block, the decoded ready state and the decoded active state is cleared (a block or core reset). However, when an instruction block is re-executed on the core, such as when it branches back to itself (a block refresh), only active ready state is cleared. Block refreshes can occur immediately (when an instruction block branches to itself) or after executing a number of other intervening instruction blocks. The decoded ready state for the instruction block can thus be preserved so that it is not necessary to re-fetch and decode the block's instructions. Hence, block refresh can be used to save time and energy in loops and other repeating program structures.

The number of instructions that are stored in each instruction window generally corresponds to the number of instructions within an instruction block. In some examples, the number of instructions within an instruction block can be 32, 64, 128, 1024, or another number of instructions. In some examples of the disclosed technology, an instruction block is allocated across multiple instruction windows within a processor core. In some examples, the instruction windows 210, 211 can be logically partitioned so that multiple instruction blocks can be executed on a single processor core. For example, one, two, four, or another number of instruction blocks can be executed on one core. The respective instruction blocks can be executed concurrently or sequentially with each other.

Instructions can be allocated and scheduled using the control unit 205 located within the processor core 111. The control unit 205 orchestrates fetching of instructions from memory, decoding of the instructions, execution of instructions once they have been loaded into a respective instruction window, data flow into/out of the processor core 111, and control signals input and output by the processor core. For example, the control unit 205 can include the ready queue, as described above, for use in scheduling instructions. The instructions stored in the memory store 215 and 216 located in each respective instruction window 210 and 211 can be executed atomically. Thus, updates to the visible architectural state (such as the register file 230 and the memory) affected by the executed instructions can be buffered locally within the core until the instructions are committed. The control unit 205 can determine when instructions are ready to be committed, sequence the commit logic, and issue a commit signal. For example, a commit phase for an instruction block can begin when all register writes are buffered, all writes to memory are buffered, and a branch target is calculated. The instruction block can be committed when updates to the visible architectural state are complete. For example, an instruction block can be committed when the register writes are written to the register file, the stores are sent to a load/store unit or memory controller, and the commit signal is generated. The control unit 205 also controls, at least in part, allocation of functional units 260 to each of the respective instructions windows.

As shown in FIG. 2, a first router 250, which has a number of execution pipeline registers 255, is used to send data from either of the instruction windows 210 and 211 to one or more of the functional units 260, which can include but are not limited to, integer ALUs (arithmetic logic units) (e.g., integer ALUs 264 and 265), floating point units (e.g., floating point ALU 267), shift/rotate logic (e.g., barrel shifter 268), or other suitable execution units, which can including graphics functions, physics functions, and other mathematical operations. Data from the functional units 260 can then be routed through a second router 270 to outputs 290, 291, and 292, routed back to an operand buffer (e.g. LOP buffer 242 and/or ROP buffer 243), or fed back to another functional unit, depending on the requirements of the particular instruction being executed. The second router 270 can include a load/store queue 275, which can be used to issue memory instructions, a data cache 277, which stores data being output from the core to memory, and load/store pipeline register 278.

The core also includes control outputs 295 which are used to indicate, for example, when execution of all of the instructions for one or more of the instruction windows 210 or 211 has completed. When execution of an instruction block is complete, the instruction block is designated as “committed” and signals from the control outputs 295 can in turn can be used by other cores within the block-based processor 100 and/or by the control unit 160 to initiate scheduling, fetching, and execution of other instruction blocks. Both the first router 250 and the second router 270 can send data back to the instruction (for example, as operands for other instructions within an instruction block).

As will be readily understood to one of ordinary skill in the relevant art, the components within an individual core are not limited to those shown in FIG. 2, but can be varied according to the requirements of a particular application. For example, a core may have fewer or more instruction windows, a single instruction decoder might be shared by two or more instruction windows, and the number of and type of functional units used can be varied, depending on the particular targeted application for the block-based processor. Other considerations that apply in selecting and allocating resources with an instruction core include performance requirements, energy usage requirements, integrated circuit die, process technology, and/or cost.

It will be readily apparent to one of ordinary skill in the relevant art that trade-offs can be made in processor performance by the design and allocation of resources within the instruction window (e.g., instruction window 210) and control logic 205 of the processor cores 110. The area, clock period, capabilities, and limitations substantially determine the realized performance of the individual cores 110 and the throughput of the block-based processor cores 110.

The instruction scheduler 206 can have diverse functionality. In certain higher performance examples, the instruction scheduler is highly concurrent. For example, each cycle, the decoder(s) write instructions' decoded ready state and decoded instructions into one or more instruction windows, selects the next instruction to issue, and, in response the back end sends ready events—either target-ready events targeting a specific instruction's input slot (predicate, left operand, right operand, etc.), or broadcast-ready events targeting all instructions. The per-instruction ready state bits, together with the decoded ready state can be used to determine that the instruction is ready to issue.

In some examples, the instruction scheduler 206 is implemented using storage (e.g., first-in first-out (FIFO) queues, content addressable memories (CAMs)) storing data indicating information used to schedule execution of instruction blocks according to the disclosed technology. For example, data regarding instruction dependencies, transfers of control, speculation, branch prediction, and/or data loads and stores are arranged in storage to facilitate determinations in mapping instruction blocks to processor cores. For example, instruction block dependencies can be associated with a tag that is stored in a FIFO or CAM and later accessed by selection logic used to map instruction blocks to one or more processor cores. In some examples, the instruction scheduler 206 is implemented using a general purpose processor coupled to memory, the memory being configured to store data for scheduling instruction blocks. In some examples, instruction scheduler 206 is implemented using a special purpose processor or using a block-based processor core coupled to the memory. In some examples, the instruction scheduler 206 is implemented as a finite state machine coupled to the memory. In some examples, an operating system executing on a processor (e.g., a general purpose processor or a block-based processor core) generates priorities, predictions, and other data that can be used at least in part to schedule instruction blocks with the instruction scheduler 206. As will be readily apparent to one of ordinary skill in the relevant art, other circuit structures, implemented in an integrated circuit, programmable logic, or other suitable logic can be used to implement hardware for the instruction scheduler 206.

In some cases, the scheduler 206 accepts events for target instructions that have not yet been decoded and must also inhibit reissue of issued ready instructions. Instructions can be non-predicated, or predicated (based on a true or false condition). A predicated instruction does not become ready until it is targeted by another instruction's predicate result, and that result matches the predicate condition. If the associated predicate does not match, the instruction never issues. In some examples, predicated instructions may be issued and executed speculatively. In some examples, a processor may subsequently check that speculatively issued and executed instructions were correctly speculated. In some examples a misspeculated issued instruction and the specific transitive closure of instructions in the block that consume its outputs may be re-executed, or misspeculated side effects annulled. In some examples, discovery of a misspeculated instruction leads to the complete roll back and re-execution of an entire block of instructions.

### V. Example Stream of Instruction Blocks

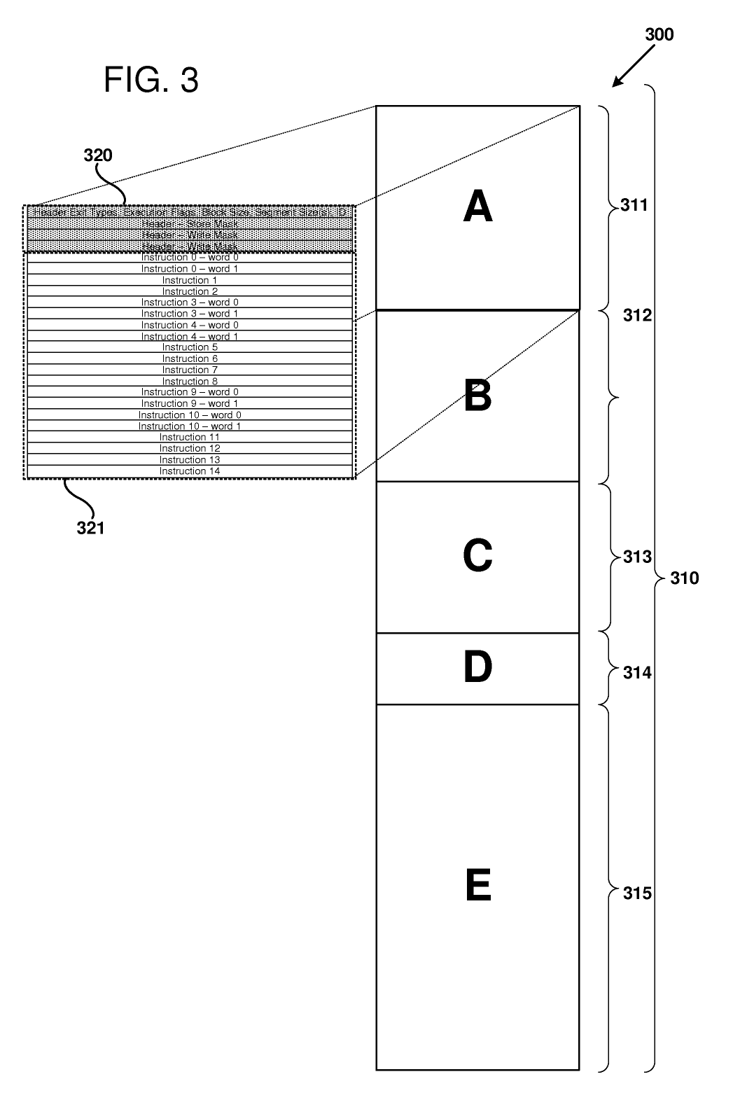

Turning now to the diagram 300 of FIG. 3, a portion 310 of a stream of block-based instructions, including a number of variable length instruction blocks 311-315 (A-E) is illustrated. The stream of instructions can be used to implement programs for user applications, system services, operating system kernels, or any other suitable use. In the example shown in FIG. 3, each instruction block begins with an instruction header, which is followed by a varying number of variable-length instructions. For example, the instruction block 311 includes a header 320 and fifteen instructions 321. The instructions 321 include instructions having a word length (e.g., instructions 1, 2, 5, and 6) and instructions having a double-word length (e.g., instructions 0, 3, 4, and 9). Various sizes or lengths of instructions are possible, including 16-, 24-, 32-, 48-, and 64-bit instructions, for example. The particular instruction header 320 illustrated includes a number of data fields that control, in part, execution of the instructions within the instruction block, and also allow for improved performance enhancement techniques including, for example, parallel fetch and decode, branch prediction, speculative execution, lazy evaluation, and/or other techniques. The instruction header 320 can also include an ID bit which indicates that the header is an instruction header and not an instruction.

The instruction header 320 includes an indication of the instruction block size. The instruction block size can be specified as a number of addresses or instructions. For example, the instruction block size can specify a number of instructions, bytes, words, or larger chunks of instructions than one. As a specific example, the instruction block size can indicate the number of 4-word chunks contained within the instruction block. In other words, the size of the block is shifted 4 bits in order to compress header space allocated to specifying instruction block size. Thus, a size value of 0 indicates a minimally-sized instruction block which is a block header followed by four words or instructions. In some examples, the instruction block size is expressed as a number of bytes, as a number of words, as a number of n-word chunks, as an address, as an address offset, or using other suitable expressions for describing the size of instruction blocks. In some examples, the instruction block size is indicated by a terminating bit pattern in the instruction block header and/or footer.

The instructions 321 can be organized into one or more sub-blocks or segments of the instruction block 311, and the instruction block header 320 can include information for locating designated starting positions of the one or more sub-blocks. A given sub-block can include instructions having two or more different lengths (e.g., some instructions can be 32 bits long, some instructions can be 64 bits long, and so forth), and the instructions can be packed so that no more than a maximum number of instructions can be within each of the sub-blocks. For example, the ISA can specify a predefined maximum number of instructions per sub-block. Additionally or alternatively, a given sub-block can include instructions of a single length, and different sub-blocks may have instructions of different lengths. In one embodiment, the instruction block size can be determined in part by adding the size of the individual sub-blocks of the instruction block 311.

The instruction block header 320 can also include execution flags, which indicate special instruction execution requirements. For example, branch prediction or memory dependence prediction can be inhibited for certain instruction blocks, depending on the particular application.

In some examples of the disclosed technology, the instruction header 320 includes one or more identification bits that indicate that the encoded data is an instruction header. For example, in some block-based processor ISAs, a single ID bit in the least significant bit space is always set to the binary value 1 to indicate the beginning of a valid instruction block. In other examples, different bit encodings can be used for the identification bit(s). In some examples, the instruction header 320 includes information indicating a particular version of the ISA for which the associated instruction block is encoded.

The block instruction header can also include a number of block exit types for use in, for example, branch prediction, control flow determination, and/or bad jump detection. The exit type can indicate what the type of branch instructions are, for example: sequential branch instructions, which point to the next contiguous instruction block in memory; offset instructions, which are branches to another instruction block at a memory address calculated relative to an offset; subroutine calls, or subroutine returns. By encoding the branch exit types in the instruction header, the branch predictor can begin operation, at least partially, before branch instructions within the same instruction block have been fetched and/or decoded.

The instruction block header 320 also includes a store mask which identifies the load-store queue identifiers that are assigned to store operations. The instruction block header can also include a write mask, which identifies which global register(s) the associated instruction block will write. The associated register file must receive a write to each entry before the instruction block can complete. In some examples a block-based processor architecture can include not only scalar instructions, but also single-instruction multiple-data (SIMD) instructions, that allow for operations with a larger number of data operands within a single instruction.

### VI. Example Block Instruction Target Encoding

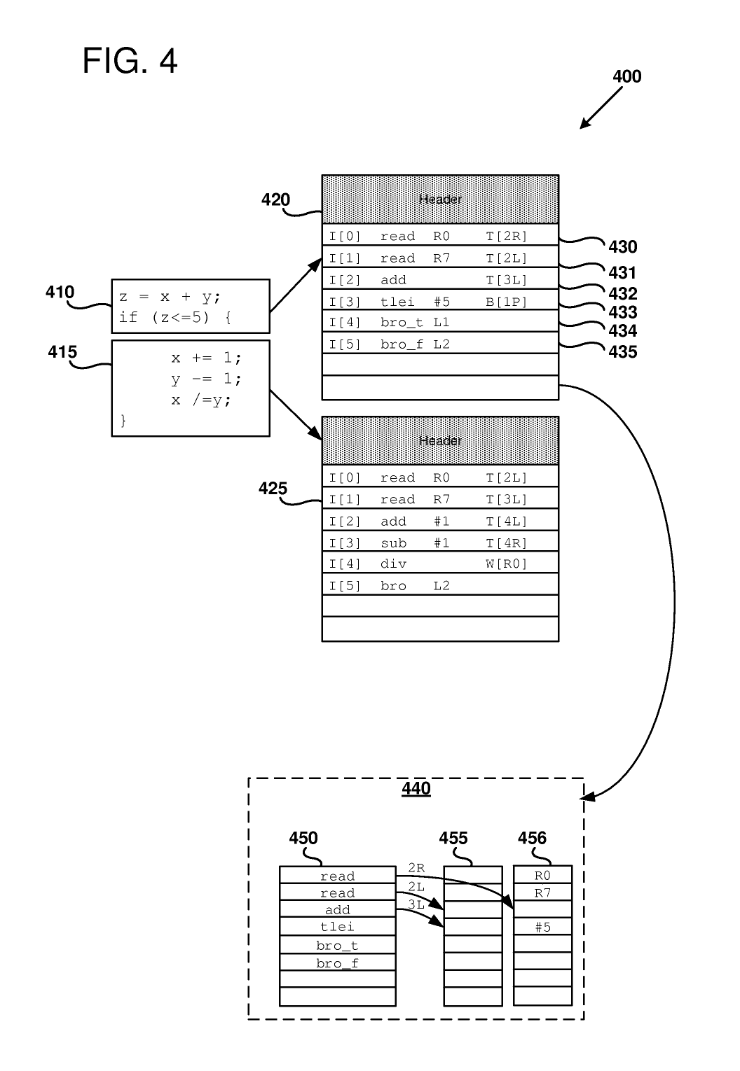

FIG. 4 is a diagram 400 depicting an example of two portions 410 and 415 of C language source code and their respective instruction blocks 420 and 425 (in assembly language), illustrating how block-based instructions can explicitly encode their targets. The high-level C language source code can be translated to the low-level assembly language and machine code by a compiler whose target is a block-based processor. A high-level language can abstract out many of the details of the underlying computer architecture so that a programmer can focus on functionality of the program. In contrast, the machine code encodes the program according to the target computer's ISA so that it can be executed on the target computer, using the computer's hardware resources. Assembly language is a human-readable form of machine code.

In this example, the first two READ instructions 430 and 431 target the right (T[2R]) and left (T[2L]) operands, respectively, of the ADD instruction 432. In the illustrated ISA, the read instruction is the only instruction that reads from the global register file (e.g., register file 230); however any instruction can target, the global register file. When the ADD instruction 432 receives the result of both register reads it will become ready and execute.

When the TLEI (test-less-than-equal-immediate) instruction 433 receives its single input operand from the ADD, it will become ready and execute. The test then produces a predicate operand that is broadcast on channel one (B[1P]) to all instructions listening on the broadcast channel, which in this example are the two predicated branch instructions (BRO_T 434 and BRO_F 435). The branch that receives a matching predicate will fire.

A dependence graph 440 for the instruction block 420 is also illustrated, as an array 450 of instruction nodes and their corresponding operand targets 455 and 456. This illustrates the correspondence between the block instructions 420, the corresponding instruction window entries, and the underlying dataflow graph represented by the instructions. Here decoded instructions READ 430 and READ 431 are ready to issue, as they have no input dependencies. As they issue and execute, the values read from registers R6 and R7 are written into the right and left operand buffers of ADD 432, marking the left and right operands of ADD 432 “ready.” As a result, the ADD 432 instruction becomes ready, issues to an ALU, executes, and the sum is written to the left operand of TLEI 433.

As a comparison, a conventional out-of-order RISC or CISC processor would dynamically build the dependence graph at runtime, using additional hardware complexity, power, area and reducing clock frequency and performance. However, the dependence graph is known statically at compile time and an EDGE compiler can directly encode the producer-consumer relations between the instructions through the ISA, freeing the microarchitecture from rediscovering them dynamically. This can potentially enable a simpler microarchitecture, reducing area, power and boosting frequency and performance.

### VII. Example Block-Based Instruction Formats

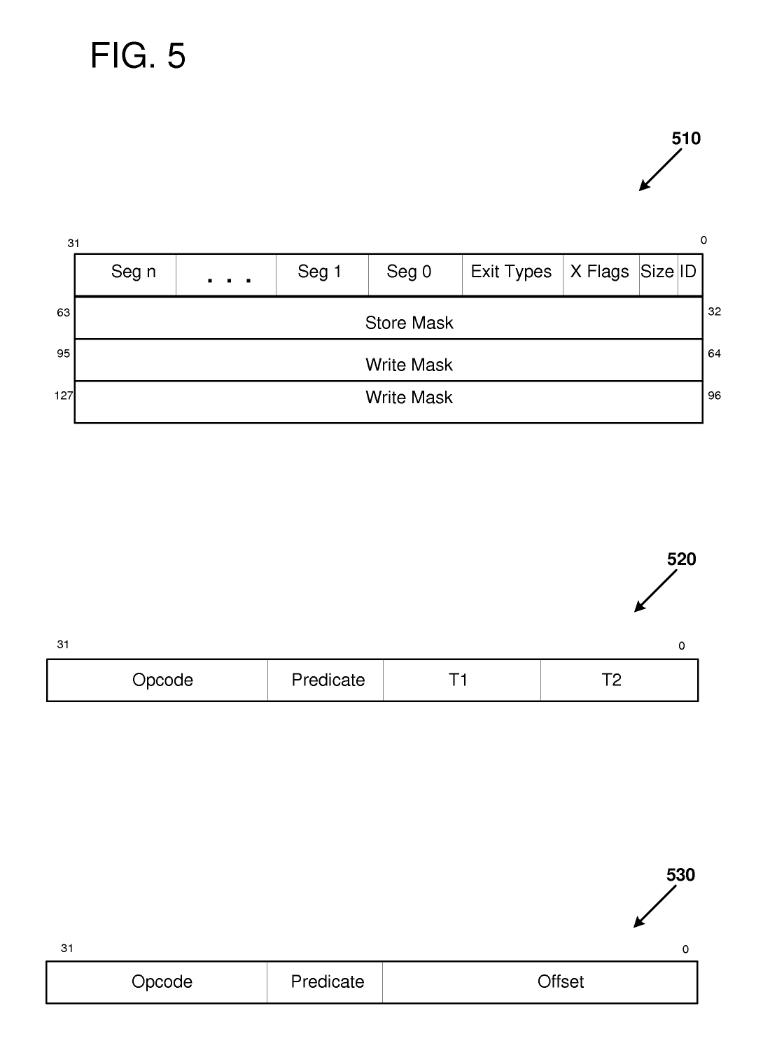

FIG. 5 is a diagram illustrating generalized examples of instruction formats for an instruction header 510, a generic instruction 520, and a branch instruction 530. Each of the instruction headers or instructions is labeled according to the number of bits. For example the instruction header 510 includes four 32-bit words and is labeled from its least significant bit (lsb) (bit 0) up to its most significant bit (msb) (bit 127). As shown, the instruction header includes a write mask field (bits 64-127), a store mask field (bits 32-63), a number of segment fields (Seg. 0-Seg. n), a number of exit type fields, a number of execution flag fields, an instruction block size field, and an instruction header ID bit (the least significant bit of the instruction header, e.g., bit 0).

The segment fields can be used to determine starting positions of one or more segments within the instruction block. For example, a respective segment field can indicate a size (e.g., bytes, words, or number of instructions) of the corresponding segment, or an offset (e.g., from the start of the instruction block, from the end of the instruction header, from a previous segment, and so forth) to a segment. Various types of segments are possible, such as a segment having a maximum number of uniform or variable length instructions; and a segment having a variable number of uniform length instructions. A given ISA can implement a single type of segment, or multiple types of segments can be used. For example, a segment type field in the instruction header can indicate the type of segments used for the instruction block. The number of bits used for a respective segment field can be defined for a given ISA. The number of bits can be a function of the number of segments of an instruction block, a maximum number of instructions per segment, and a granularity of the segments, for example.

The exit type fields include data that can be used to indicate the types of control flow instructions encoded within the instruction block. For example, the exit type fields can indicate that the instruction block includes one or more of the following: sequential branch instructions, offset branch instructions, indirect branch instructions, call instructions, and/or return instructions. In some examples, the branch instructions can be any control flow instructions for transferring control flow between instruction blocks, including relative and/or absolute addresses, and using a conditional or unconditional predicate. The exit type fields can be used for branch prediction and speculative execution in addition to determining implicit control flow instructions. In some examples, up to six exit types can be encoded in the exit type fields, and the correspondence between fields and corresponding explicit or implicit control flow instructions can be determined by, for example, examining control flow instructions in the instruction block.

The illustrated generic block instruction 520 is stored as one 32-bit word and includes an opcode field, a predicate field, a broadcast ID field (BID), a first target field (T1), and a second target field (T2). For instructions with more consumers than target fields, a compiler can build a fanout tree using move instructions, or it can assign high-fanout instructions to broadcasts. Broadcasts support sending an operand over a lightweight network to any number of consumer instructions in a core. A broadcast identifier can be encoded in the generic block instruction 520.

While the generic instruction format outlined by the generic instruction 520 can represent some or all instructions processed by a block-based processor, it will be readily understood by one of skill in the art that, even for a particular example of an ISA, one or more of the instruction fields may deviate from the generic format for particular instructions. The opcode field specifies the length or width of the instruction 520 and the operation(s) performed by the instruction 520, such as memory read/write, register load/store, add, subtract, multiply, divide, shift, rotate, system operations, or other suitable instructions. The predicate field specifies the condition under which the instruction will execute. For example, the predicate field can specify the value “true,” and the instruction will only execute if a corresponding condition flag matches the specified predicate value. In some examples, the predicate field specifies, at least in part, which is used to compare the predicate, while in other examples, the execution is predicated on a flag set by a previous instruction (e.g., the preceding instruction in the instruction block). In some examples, the predicate field can specify that the instruction will always, or never, be executed. Thus, use of the predicate field can allow for denser object code, improved energy efficiency, and improved processor performance, by reducing the number of branch instructions.

The target fields T1 and T2 specifying the instructions to which the results of the block-based instruction are sent. For example, an ADD instruction at instruction slot 5 can specify that its computed result will be sent to instructions at slots 3 and 10. Depending on the particular instruction and ISA, one or both of the illustrated target fields can be replaced by other information, for example, the first target field T1 can be replaced by an immediate operand, an additional opcode, specify two targets, etc.

The branch instruction 530 includes an opcode field, a predicate field, a broadcast ID field (BID), and an offset field. The opcode and predicate fields are similar in format and function as described regarding the generic instruction. The offset can be expressed in units of four instructions, thus extending the memory address range over which a branch can be executed. The predicate shown with the generic instruction 520 and the branch instruction 530 can be used to avoid additional branching within an instruction block. For example, execution of a particular instruction can be predicated on the result of a previous instruction (e.g., a comparison of two operands). If the predicate is false, the instruction will not commit values calculated by the particular instruction. If the predicate value does not match the required predicate, the instruction does not issue. For example, a BRO_F (predicated false) instruction will issue if it is sent a false predicate value.

It should be readily understood that, as used herein, the term “branch instruction” is not limited to changing program execution to a relative memory location, but also includes jumps to an absolute or symbolic memory location, subroutine calls and returns, and other instructions that can modify the execution flow. In some examples, the execution flow is modified by changing the value of a system register (e.g., a program counter PC or instruction pointer), while in other examples, the execution flow can be changed by modifying a value stored at a designated location in memory. In some examples, a jump register branch instruction is used to jump to a memory location stored in a register. In some examples, subroutine calls and returns are implemented using jump and link and jump register instructions, respectively.

Various other instruction formats are possible for a given ISA. For example, instruction formats having lengths of 24-, 48-, and/or 64-bits are possible and can be distinguished by providing different opcodes for different length instructions. For example, the generic block instruction 520 can be modified from a 32-bit length to a 23-bit length by removing one of the target fields and changing the opcode of the 23-bit instruction. It may be desirable to keep the instruction widths on byte boundaries, so a twenty-fourth bit can be used for additional functionality or kept as a reserved bit. As another example, the block instruction 520 can be modified from a 32-bit length to a larger bit length by adding additional target fields and changing the opcode of the larger instruction. A larger instruction length can also allow for larger immediate values.

### VIII. Example States of a Processor Core

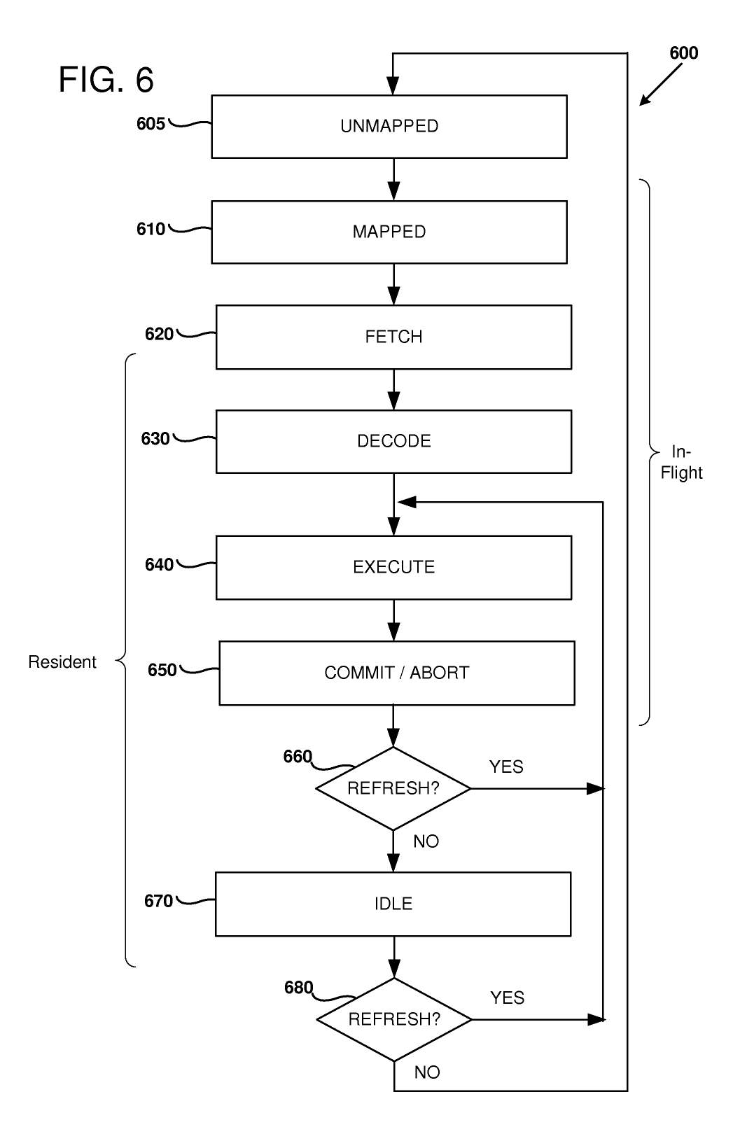

FIG. 6 is a flowchart illustrating an example of a progression of states 600 of a processor core of a block-based computer. The block-based computer is composed of multiple processor cores that are collectively used to run or execute a software program. The program can be written in a variety of high-level languages and then compiled for the block-based processor using a compiler that targets the block-based processor. The compiler can emit code that, when run or executed on the block-based processor, will perform the functionality specified by the high-level program. The compiled code can be stored in a computer-readable memory that can be accessed by the block-based processor. The compiled code can include a stream of variable length instructions grouped into a series of instruction blocks. The instruction blocks can be further grouped into sub-blocks or segments. During execution, one or more of the instruction blocks can be executed by the block-based processor to perform the functionality of the program. Typically, the program will include more instruction blocks than can be executed on the cores at any one time. Thus, blocks of the program are mapped to respective cores, the cores perform the work specified by the blocks, and then the blocks on respective cores are replaced with different blocks until the program is complete. Some of the instruction blocks may be executed more than once, such as during a loop or a subroutine of the program. An “instance” of an instruction block can be created for each time the instruction block will be executed. Thus, each repetition of an instruction block can use a different instance of the instruction block. As the program is run, the respective instruction blocks can be mapped to and executed on the processor cores based on architectural constraints, available hardware resources, and the dynamic flow of the program. During execution of the program, the respective processor cores can transition through a progression of states 600, so that one core can be in one state and another core can be in a different state.

At state 605, a state of a respective processor core can be unmapped. An unmapped processor core is a core that is not currently assigned to execute an instance of an instruction block. For example, the processor core can be unmapped before the program begins execution on the block-based computer. As another example, the processor core can be unmapped after the program begins executing but not all of the cores are being used. In particular, the instruction blocks of the program are executed, at least in part, according to the dynamic flow of the program. Some parts of the program may flow generally serially or sequentially, such as when a later instruction block depends on results from an earlier instruction block. Other parts of the program may have a more parallel flow, such as when multiple instruction blocks can execute at the same time without using the results of the other blocks executing in parallel. Fewer cores can be used to execute the program during more sequential streams of the program and more cores can be used to execute the program during more parallel streams of the program.

At state 610, the state of the respective processor core can be mapped. A mapped processor core is a core that is currently assigned to execute an instance of an instruction block. When the instruction block is mapped to a specific processor core, the instruction block is in-flight. An in-flight instruction block is a block that is targeted to a particular core of the block-based processor, and the block will be or is executing, either speculatively or non-speculatively, on the particular processor core. In particular, the in-flight instruction blocks correspond to the instruction blocks mapped to processor cores in states 610-650. A block executes non-speculatively when it is known during mapping of the block that the program will use the work provided by the executing instruction block. A block executes speculatively when it is not known during mapping whether the program will or will not use the work provided by the executing instruction block. Executing a block speculatively can potentially increase performance, such as when the speculative block is started earlier than if the block were to be started after or when it is known that the work of the block will be used. However, executing speculatively can potentially increase the energy used when executing the program, such as when the speculative work is not used by the program.

A block-based processor includes a finite number of homogeneous or heterogeneous processor cores. A typical program can include more instruction blocks than can fit onto the processor cores. Thus, the respective instruction blocks of a program will generally share the processor cores with the other instruction blocks of the program. In other words, a given core may execute the instructions of several different instruction blocks during the execution of a program. Having a finite number of processor cores also means that execution of the program may stall or be delayed when all of the processor cores are busy executing instruction blocks and no new cores are available for dispatch. When a processor core becomes available, an instance of an instruction block can be mapped to the processor core.

An instruction block scheduler can assign which instruction block will execute on which processor core and when the instruction block will be executed. The mapping can be based on a variety of factors, such as a target energy to be used for the execution, the number and configuration of the processor cores, the current and/or former usage of the processor cores, the dynamic flow of the program, whether speculative execution is enabled, a confidence level that a speculative block will be executed, and other factors. An instance of an instruction block can be mapped to a processor core that is currently available (such as when no instruction block is currently executing on it). In one embodiment, the instance of the instruction block can be mapped to a processor core that is currently busy (such as when the core is executing a different instance of an instruction block) and the later-mapped instance can begin when the earlier-mapped instance is complete.

At state 620, the state of the respective processor core can be fetch. For example, the IF pipeline stage of the processor core can be active during the fetch state. Fetching an instruction block can include transferring the block from memory (such as the L1 cache, the L2 cache, or main memory) to the processor core, and reading instructions from local buffers of the processor core so that the instructions can be decoded. For example, the instructions of the instruction block can be loaded into an instruction cache, buffer, or registers of the processor core. Multiple instructions, from one or more segments, can be fetched in parallel (e.g., at the same time) during the same clock cycle. The fetch state can be multiple cycles long and can overlap with the decode (630) and execute (640) states when the processor core is pipelined.

When instructions of the instruction block are loaded onto the processor core, the instruction block is resident on the processor core. The instruction block is partially resident when some, but not all, instructions of the instruction block are loaded. The instruction block is fully resident when all instructions of the instruction block are loaded. The instruction block will be resident on the processor core until the processor core is reset or a different instruction block is fetched onto the processor core. In particular, an instruction block is resident in the processor core when the core is in states 620-670.

At state 630, the state of the respective processor core can be decode. For example, the DC pipeline stage of the processor core can be active during the fetch state. During the decode state, instructions of the instruction block are being decoded so that they can be stored in the memory store of the instruction window of the processor core. In particular, the instructions can be transformed from relatively compact machine code, to a less compact representation that can be used to control hardware resources of the processor core. Multiple instructions, from one or more segments, can be decoded in parallel during the same clock cycle. The decode state can be multiple cycles long and can overlap with the fetch (620) and execute (640) states when the processor core is pipelined. After an instruction of the instruction block is decoded, it can be executed when all dependencies of the instruction are met.

At state 640, the state of the respective processor core can be execute. During the execute state, instructions of the instruction block are being executed. In particular, the EX and/or LS pipeline stages of the processor core can be active during the execute state. The instruction block can be executing speculatively or non-speculatively. A speculative block can execute to completion or it can be terminated prior to completion, such as when it is determined that work performed by the speculative block will not be used. When an instruction block is terminated, the processor can transition to the abort state. A speculative block can complete when it is determined the work of the block will be used, all register writes are buffered, all writes to memory are buffered, and a branch target is calculated, for example. A non-speculative block can execute to completion when all register writes are buffered, all writes to memory are buffered, and a branch target is calculated, for example. The execute state can be multiple cycles long and can overlap with the fetch (620) and decode (630) states when the processor core is pipelined. When the instruction block is complete, the processor can transition to the commit state.

At state 650, the state of the respective processor core can be commit or abort. During commit, the work of the instructions of the instruction block can be atomically committed so that other blocks can use the work of the instructions. In particular, the commit state can include a commit phase where locally buffered architectural state is written to architectural state that is visible to or accessible by other processor cores. When the visible architectural state is updated, a commit signal can be issued and the processor core can be released so that another instruction block can be executed on the processor core. During the abort state, the pipeline of the core can be halted to reduce dynamic power dissipation. In some applications, the core can be power gated to reduce static power dissipation. At the conclusion of the commit/abort states, the processor core can receive a new instruction block to be executed on the processor core, the core can be refreshed, the core can be idled, or the core can be reset.

At state 660, it can be determined if the instruction block resident on the processor core can be refreshed. As used herein, an instruction block refresh or a processor core refresh means enabling the processor core to re-execute one or more instruction blocks that are resident on the processor core. In one embodiment, refreshing a core can include resetting the active-ready state for one or more instruction blocks. It may be desirable to re-execute the instruction block on the same processor core when the instruction block is part of a loop or a repeated sub-routine or when a speculative block was terminated and is to be re-executed. The decision to refresh can be made by the processor core itself (contiguous reuse) or by outside of the processor core (non-contiguous reuse). For example, the decision to refresh can come from another processor core or a control core performing instruction block scheduling. There can be a potential energy savings when an instruction block is refreshed on a core that already executed the instruction as opposed to executing the instruction block on a different core. Energy is used to fetch and decode the instructions of the instruction block, but a refreshed block can save most of the energy used in the fetch and decode states by bypassing these states. In particular, a refreshed block can re-start at the execute state (640) because the instructions have already been fetched and decoded by the core. When a block is refreshed, the decoded instructions and the decoded ready state can be maintained while the active ready state is cleared. The decision to refresh an instruction block can occur as part of the commit operations or at a later time. If an instruction block is not refreshed, the processor core can be idled.

At state 670, the state of the respective processor core can be idle. The performance and power consumption of the block-based processor can potentially be adjusted or traded off based on the number of processor cores that are active at a given time. For example, performing speculative work on concurrently running cores may increase the speed of a computation but increase the power if the speculative misprediction rate is high. As another example, immediately allocating new instruction blocks to processors after committing or aborting an earlier executed instruction block may increase the number of processors executing concurrently, but may reduce the opportunity to reuse instruction blocks that were resident on the processor cores. Reuse may be increased when a cache or pool of idle processor cores is maintained. For example, when a processor core commits a commonly used instruction block, the processor core can be placed in the idle pool so that the core can be refreshed the next time that the same instruction block is to be executed. As described above, refreshing the processor core can save the time and energy used to fetch and decode the resident instruction block. The instruction blocks/processor cores to place in an idle cache can be determined based on a static analysis performed by the compiler or a dynamic analysis performed by the instruction block scheduler. For example, a compiler hint indicating potential reuse of the instruction block can be placed in the header of the block and the instruction block scheduler can use the hint to determine if the block will be idled or reallocated to a different instruction block after committing the instruction block. When idling, the processor core can be placed in a low-power state to reduce dynamic power consumption, for example.

At state 680, it can be determined if the instruction block resident on the idle processor core can be refreshed. If the core is to be refreshed, the block refresh signal can be asserted and the core can transition to the execute state (640). If the core is not going to be refreshed, the block reset signal can be asserted and the core can transition to the unmapped state (605). When the core is reset, the core can be put into a pool with other unmapped cores so that the instruction block scheduler can allocate a new instruction block to the core.

### IX. Examples of Block-Based Compiler Methods

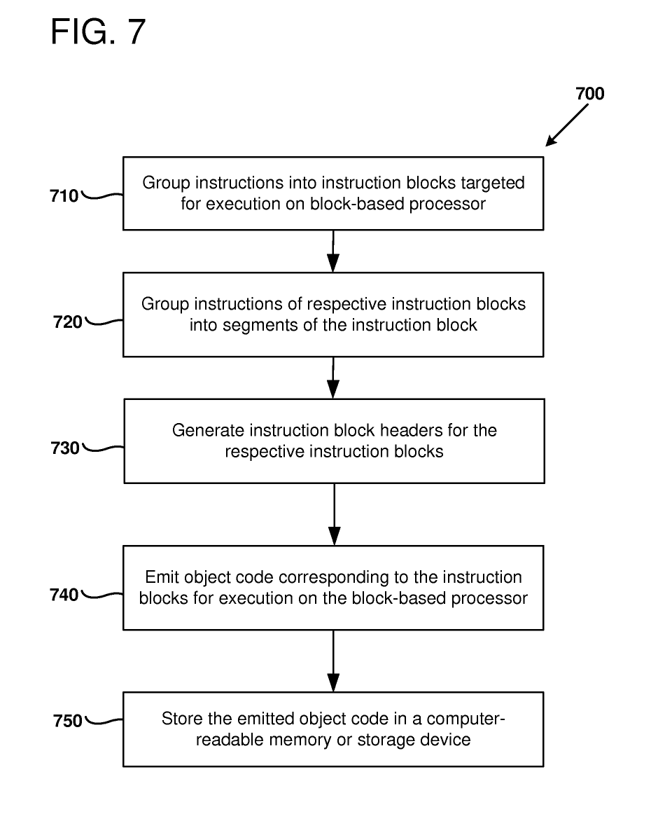

FIG. 7 is a flowchart illustrating an example method 700 for compiling to a block-based computer architecture. The method 700 can be implemented in software of a compiler executing on a block-based processor or a conventional processor. The compiler can transform high-level source code (such as C, C++, or Java) of a program, in one or more phases or passes, into low-level object or machine code that is executable on the targeted block-based processor. For example, the compiler phases can include: lexical analysis for generating a stream of tokens from the source code; syntax analysis or parsing for comparing the stream of tokens to a grammar of the source code language and generating a syntax or parse tree; semantic analysis for performing various static checks (such as type-checking, checking that variables are declared, and so forth) on the syntax tree and generating an annotated or abstract syntax tree; generation of intermediate code from the abstract syntax tree; optimization of the intermediate code; and machine code generation for producing the machine code for the targeted processor from the intermediate code. The machine code can be stored into a memory of the block-based processor so that the block-based processor can execute the program.

At process block 710, instructions can be grouped into instruction blocks targeted for execution on a block-based processor. For example, the compiler can generate machine code as a sequential stream of instructions which can be grouped into instruction blocks according to the block-based computer's hardware resources and the data and control flow of the code. For example, a given instruction block can include a single basic block, a portion of a basic block, or multiple basic blocks, so long as the instruction block can be executed within the constraints of the ISA and the hardware resources of the targeted computer. A basic block is a block of code where control can only enter the block at the first instruction of the block and control can only leave the block at the last instruction of the basic block. Thus, a basic block is a sequence of instructions that are executed together. Multiple basic blocks can be combined into a single instruction block using predicated instructions so that intra-instruction-block branches are converted to dataflow instructions.

The instructions can be grouped so that the resources of the processor cores are not exceeded and/or are efficiently utilized. For example, the processor cores can include a fixed number of resources, such as one or more instruction windows, a fixed number of load and store queue entries, and so forth. The instructions can be grouped to have fewer instructions per group than are available within an instruction window. For example, an instruction window may have storage capacity for 32 instructions, a first basic block may have 8 instructions, and the first basic block may conditionally branch to a second basic block having 23 instructions. The two basic blocks can be grouped together into one instruction block so that the grouping includes 31 instructions (less than the 32-instruction capacity) and the instructions of the second basic block are predicated on the branch condition being true. As another example, an instruction window may have storage capacity for 32 instructions and a basic block may have 38 instructions. The first 31 instructions can be grouped into one instruction block with an unconditional branch (the thirty-second instruction) and the next 7 instructions can be grouped into a second instruction block. As another example, an instruction window may have storage capacity for thirty-two instructions and a loop body may include eight instructions and be repeated three times. Grouping can include unrolling the loop by combining the multiple iterations of the loop body within a larger loop body. By unrolling the loop, the number of instructions within the instruction block can be increased and the instruction window resource can potentially be more efficiently utilized.

At process block 720, instructions of a respective instruction block can be grouped into segments of the respective instruction block. The number and organization of the segments can be defined by the ISA of the targeted block-based processor. A segment is a contiguous range of storage locations for instructions. Thus, an instruction block can include an instruction header and instructions, where the instructions are organized into one or more segments that are associated with the instruction header. In one embodiment, the segments are located in the storage locations immediately following the instruction header so that the instruction block can be stored in a contiguous section of memory. The segments can begin or be aligned on different boundaries, such as a byte, word, or double-word boundary, for example. Each segment can include a fixed or variable number of instructions, and a fixed or variable amount of storage locations. The instructions within a segment can be of a uniform length or of different lengths. The instructions within a segment can be tightly packed so that all bytes within the segment are part of an instruction. Alternatively, there can be padding (non-instruction bytes) between instructions or at the end of the segment, such as to aid with alignment within the instruction block or between instruction blocks. It may be desirable to reduce the amount of padding so that the instructions can be packed in a smaller memory footprint which may increase cache locality and/or reduce memory access time, for example.

A particular instruction can be assigned to a segment based at least on an order of the instruction within the sequential stream of instructions, a length or size of the instruction, dependencies or resource requirements of the instruction, alignment considerations of the segment, a number of instructions of the instruction block, and/or qualities of other instructions within the given segment, such as a control flow of the instruction block, for example. In one example, the instructions can be assigned to the segments in the same sequential order as the instructions are ordered in the sequential stream of instructions. For example, the first eight instructions of an instruction block can be assigned to a first segment, the next eight instructions can be assigned to a second segment, and so on. Thus, the number of segments within an instruction block can vary, where an instruction block having a larger number of instructions can include more segments as compared to an instruction block having a smaller number of instructions.

As another example, the instructions can be assigned to the segments so that the segments are packed with a high utilization and/or aligned in memory. As a specific example, each of the segments can comprise a maximum number of instructions and the instructions can be packed into the segments. For example, the maximum number of instructions per segment can be a number predefined by the ISA. Packing the instructions into the segments can include assigning the maximum number of instructions to each segment so that all segments, except perhaps for the last segment, have the maximum number of instructions. As a specific example, an instruction block can include 30 instructions and the maximum number of instructions per segment can be 8 instructions. The instructions can be packed into segments 0-2 resulting in segments 0-2 having 8 instructions and segment 3 having 6 instructions. Here, the last segment (segment 3) was assigned the total number of instructions of the instruction block modulo the maximum number of instructions per segment. As another specific example, an instruction block can include 16 instructions and the maximum number of instructions per segment can be 8 instructions. The instructions can be packed into segments 0-1 resulting in each of segments 0-1 having exactly 8 instructions. Here, the number of instructions of the instruction block divided by the maximum number of instructions per segment is an integer (e.g., it is evenly divisible) so all of the assigned segments have the maximum number of instructions. When packing the instruction block, some segments may be assigned no instructions, such as when the number of instructions of the instruction block is relatively small compared to the size of the instruction window of the processor core.

As another example, the instructions can be packed into the segments so that the instructions are packed efficiently within the segment and/or aligned on a word or double-word boundary. For example, instructions of a given length or width can be efficiently packed into the segments by grouping the instructions in multiples of the least common multiple (LCM) of the instruction width and the alignment width. As a specific example, the ISA may include 24-, 32-, 48-, and 64-bit instructions and segments may be aligned on 32-bit or 64-bit boundaries (e.g., the alignment width is 32 or 64 bits). The LCM of 24, 32, 48, and 64 is 192, corresponding to three 64-bit instructions, four 48-bit instructions, six 32-bit instructions, and eight 24-bit instructions. The least common multiple (LCM) of 24, 32, and 48 is 96, corresponding to two 48-bit instructions, three 32-bit instructions, and four 24-bit instructions. Thus, packing four 24-bit instructions into a given segment may result in more efficient packing than only packing one or three 24-bit instructions into the given segment. When packing variable-length instructions into a segment, the instruction mix may not allow for optimal packing, so pad bytes can be added to the end of the segment so that the next segment is aligned.

As another example, the instruction block can include instructions of different lengths, but all instructions within a given segment can be the same length. Thus, different respective segments can have instructions of different lengths. For example, a first segment can include only instructions of 24-bit length, a second segment can include only instructions of 32-bit length, a third segment can include only instructions of 48-bit length, and a fourth segment can include only instructions of 64-bit length. Additionally, some segments can have instructions of the same length. For example, if 32-bit instructions are the most common instructions, the 24-, 48-, and 64-bit instructions of an instruction block can each be assigned to their own respective segments (e.g., segments 0, 1, and 2), and the 32-bit instructions can be assigned to multiple segments (e.g., segments 3 and higher).

As another example, the instructions can be grouped into the segments based on a control flow of the instruction block. For example, instructions that are independent of each other can be assigned to different segments. Thus, when the instructions from different segments are fetched and decoded in parallel, the instructions may also execute in parallel if they are independent.

It should be noted that the instructions for a block-based processor can potentially be reordered (e.g., put in different segments of the instruction block) more freely than for a conventional RISC-type processor. For a block-based processor, any intra-block dependencies of the instructions are encoded explicitly within the instructions, and the instructions will not execute until the dependencies of the instructions are satisfied. Thus, the fetch and decode order may be less important since correct program operation is enabled by the explicitly encoded dependencies of the instructions. In contrast, there is less flexibility to reorder instructions targeted to a conventional RISC-type processor because the instructions do not have explicitly encoded dependencies. Rather, the conventional instructions pass values through a shared register file or memory and re-ordering the instructions may cause the dependencies to be violated if the instructions are executed out-of-order during execution of the program.

At process block 730, instruction block headers can be generated for the respective instruction blocks. For example, the instruction block headers can be encoded in a format defined by the ISA of the targeted block-based processor. The instruction block headers can include information for determining a number of segments of the instruction block, designated starting positions of the segments within the instruction block, and a format of the segment type when the ISA supports multiple types of segments. For example, a first segment type can permit variable length instructions within a segment and a second segment type can permit only uniform length instructions within a segment. A flag in the instruction header can be used to encode the segment type of a given instruction block (e.g., a one can be used to indicate segments having variable length instructions and a zero can be used to indicate segments having uniform length instructions).

The number of segments of an instruction block can be encoded in the instruction block header associated with the instruction block. In one example, a field within the header can indicate the number segments of the instruction block. The size of the field can be selected based on a maximum number of segments supported by the ISA. For example, three bits can be used to encode eight numbers. In another example, a respective segment of the instruction block can have a segment field within the header to indicate a number of instructions of the segment or an offset to the segment or to the next segment. The number of segments of the instruction block can be calculated from the number of non-zero segment fields.

The starting positions of the segments within the instruction block can be encoded using the segment fields of the instruction block header. The number of bits used for each segment field can be based on a maximum number of instructions allowed for each segment, as governed by the ISA. Thus, if instruction header bits are at a premium, there can be a trade-off between the number of segments and the maximum number of instructions per segment. For example, there can be n segment fields for encoding the starting positions of n or n+1 segments.

In one embodiment, each segment field can indicate a size of its corresponding segment. As a specific example, an ISA can support four segments per instruction block, and a given instruction block includes 4 instructions in segment 0, 10 instructions in segment 1, 5 instructions in segment 2, and 0 instructions in segment 3. Each of the segment fields can be at least four bits wide, and the segment fields 0-3 can be encoded with the values 4, 10, 5, and 0 respectively. Since the values of three segment fields are non-zero, the number of segments of the instruction block is three. In this embodiment, n segment fields are used for encoding the sizes of n segments.

In another embodiment, each segment field can indicate an offset to its corresponding segment. Segment 0 can be specified by the ISA to start at the first address after the instruction header. Thus, segment 0 may not have a corresponding segment field since the location of segment 0 is defined by the ISA. Segment 1 can begin directly after segment 0 at the next available address and/or be aligned to a boundary following segment 0. The size of segment 0 is determined based on the number and sizes of the instructions of segment 0. The starting position of segment 1 can be encoded as an offset from the end of the instruction header and can be dependent on the size of segment 0. Thus, the offset encoded in the segment field corresponding to segment 1 can account for the size of segment 0 and any alignment padding. Similarly, the starting position higher or later segments are determined based on the number and sizes of the instructions of lower or earlier segments. The offsets for respective segments can all be relative to the end of the instruction header (e.g., making for easier decoding) or can be relative to the end of the preceding segment (e.g., making for more complicated decoding, but more compact encoding), for example.

At process block 740, object code can be emitted for the instruction blocks targeted to be executed on the block-based processor. For example, the instruction blocks can be emitted in a format defined by the ISA of the targeted block-based processor. In one embodiment, a respective instruction block can be emitted so that the instructions (grouped in segments) sequentially follow the instruction header of the instruction block. The different instruction blocks associated with a program can be emitted in various orders. As one example, the instruction blocks can be emitted in the order they are encountered when doing a depth-first or breadth-first traversal of a dependence graph of the program. In an alternative embodiment, the instruction headers can be emitted in one stream and the instructions can be emitted in a different stream.

At process block 750, the emitted object code can be stored in a computer-readable memory or storage device. For example, the emitted object code can be stored into a memory of the block-based processor so that the block-based processor can execute the program. As another example, the emitted object code can be loaded onto a storage device, such as a hard-disk drive of the block-based processor so that the block-based processor can execute the program. At run-time, all or a portion of the emitted object code can be retrieved from the storage device and loaded into memory of the block-based processor so that the block-based processor can execute the program.

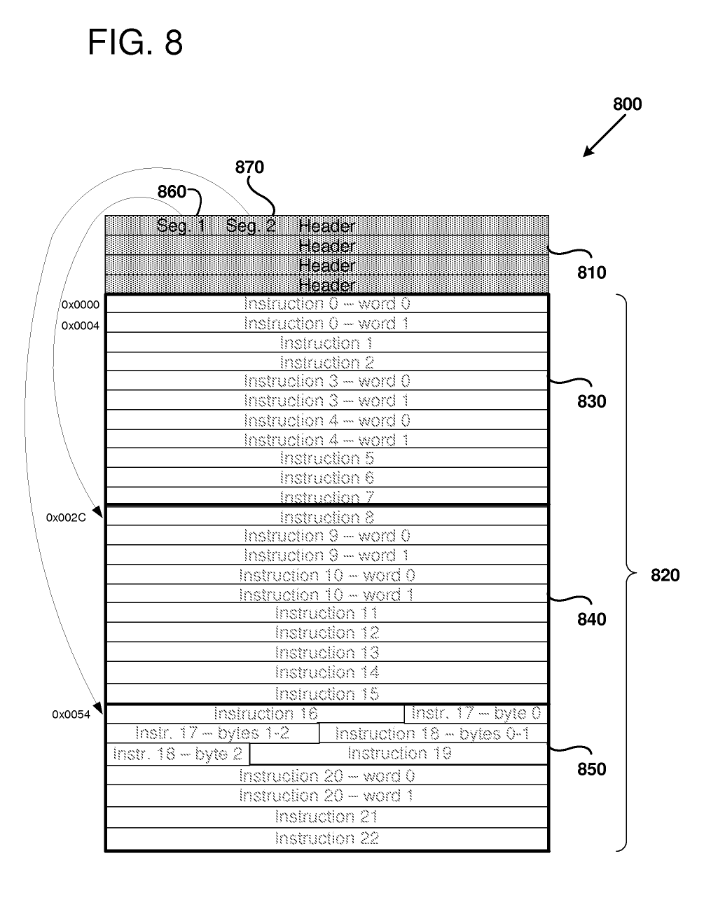

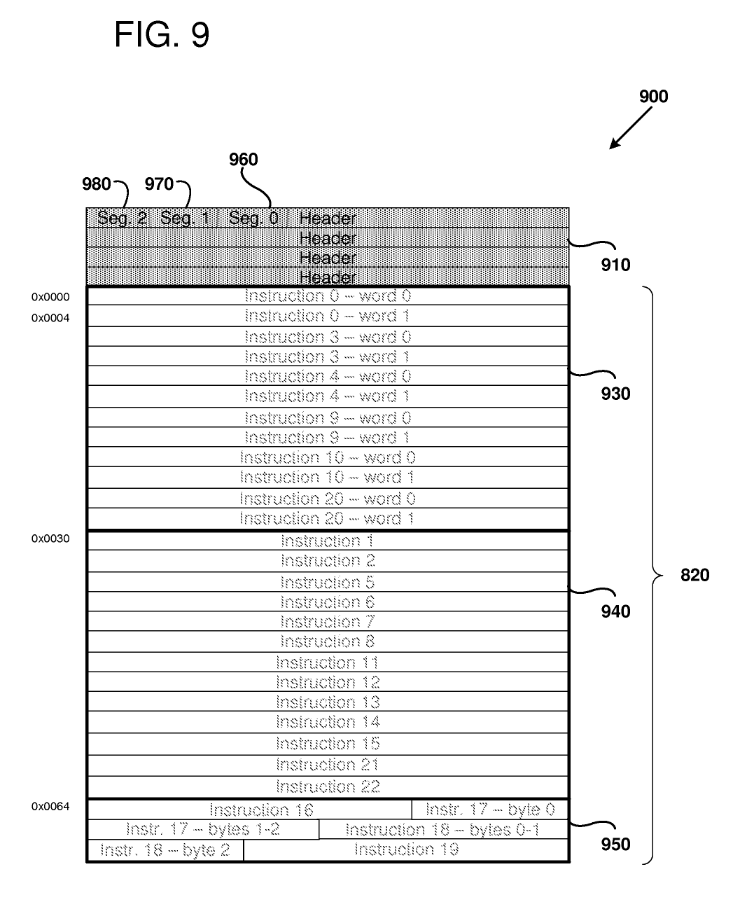

FIGS. 8-9 are examples of different arrangements of variable-length instructions within instruction blocks targeted to a block-based processor. The instruction blocks of FIGS. 8-9 can be generated by the method 700, for example. FIG. 8 is an example of an instruction block where a respective segment can have variable length instructions, and the segments are packed to have a maximum number of instructions, where the maximum is predefined by the ISA. FIG. 9 is an example of an instruction block having variable length instructions where all instructions within a respective segment are the same length.

Turning to the example of FIG. 8, an instruction block 800 includes an instruction header 810 and instructions 820. The instructions 820 are arranged or grouped in three sub-blocks or segments 830, 840, and 850. There are 23 instructions in this instruction block and the maximum number of instructions per segment is eight instructions. The first two segments have eight instructions each, where the segment 830 has three double-word instructions (instructions 0, 3, and 4) and five single-word instructions (instructions 1-2 and 5-7); and the segment 840 has two double-word instructions and six single-word instructions. The last segment 850 has only seven instructions (23 instructions modulo eight, which is the maximum number of instructions per segment), where four instructions are sub-word instructions (such as 24-bit instructions when using a 32-bit word size), one instruction is a double-word instruction, and two instructions are word instructions.

In this example, the instructions are grouped so that the segments 830, 840, 850 are aligned on word boundaries and there is no padding within the segments 830, 840, 850. The segment 830 begins directly after the instruction header at address 0x0000. In this example, the addresses are byte addressable and the word-size is four bytes (32-bits), so the address increases by four for each word. Addresses can be represented in base-16 or hexadecimal numbers (indicated by the 0x prefix) or in base-10 or decimal numbers (indicated by no prefix). The instructions in the segment 830 occupy 44 bytes, so the starting address for the segment 840 is 0x002C (44 in decimal). The instructions in the segment 840 occupy 40 bytes, so the offset from the beginning of the segment 840 to the beginning of the segment 850 is 0x0028. The starting address for the segment 850 is 0x0054 (44+40 in decimal).

The instruction header 810 can include information to determine the starting positions of the segments within the instruction block 800. In particular, the instruction header 810 can include segment fields 860 and 870 to indicate the starting positions of the segments 840 and 850, respectively. As one example, the segment field 860 can be encoded with the value 0x002C to indicate that the segment 840 begins at address 0x002C and the segment field 870 can be encoded with the value 0x0054 to indicate that the segment 850 begins at address 0x0054. Here, the offsets in the segment fields are measured relative to a common starting position (the end of the instruction header or start of the instructions). As another example, the segment field 860 can be encoded with the value 0x002C to indicate that the segment 840 begins at address 0x002C and the segment field 870 can be encoded with the value 0x0028 to indicate that the segment 850 begins at address 0x0054. Here, the offsets in the segment fields are measured relative to the starting position of the previous segment. Fewer bits can be used for encoding the starting positions when the positons are measured relative to the starting position of the previous segment. Using fewer bits can be desirable to reduce the size of the instruction header. As yet another example, the offsets can be encoded using word addresses rather than byte addresses, such as when the ISA specifies that the segments are aligned on word boundaries. A word address can be encoded with two fewer bits than a byte address. Thus, using word addresses and offsets from the preceding segment, the segment field 860 can be encoded with the value 0x000B to indicate that the segment 840 begins at byte-address 0x002C and the segment field 870 can be encoded with the value 0x000A to indicate that the segment 850 begins at byte-address 0x0054.

FIG. 9 shows an example of arranging variable-length instructions within an instruction block differently than the example in FIG. 8. Specifically, the instructions 820 of FIG. 9 are the same as the instructions 820 of FIG. 8, but the instructions 820 are grouped differently in FIG. 9. FIG. 9 shows an example of an instruction block 900 having variable length instructions 820 where all instructions within a respective segment are the same length. The instruction block 900 includes an instruction header 910 and the instructions 820. The instructions 820 are arranged or grouped in three segments 930, 940, and 950. The first segment 930 consists only of double-word instructions and includes six instructions; the second segment 940 consists only of single-word instructions and includes thirteen instructions; and the third segment 950 consists only of sub-word instructions (e.g., 24-bit instructions) and includes four instructions.

In this example, the instructions are grouped so that the segments 930, 940, 950 are aligned on word boundaries and there is no padding within the segments 930, 940, 950. The segment 930 begins directly after the instruction header at byte-address 0x0000. The instructions in the segment 930 occupy 48 bytes (6 instructions*8 bytes/instruction), so the starting address for the segment 940 is 0x0030 (48 in decimal). The instructions in the segment 940 occupy 52 bytes, so the offset from the beginning of the segment 940 to the beginning of the segment 950 is 0x0028. The starting address for the segment 950 is 0x0064 (48+52 in decimal).

The instruction header 910 can include information to determine the starting positions of the segments within the instruction block 900. In one embodiment, the starting positions of the segments can be encoded as described in reference to FIG. 8, where segment fields are used to encode an offset from the end of the instruction header or from the beginning of the previous segment using byte or word addresses.

In an alternative embodiment, the starting positions of the segments can be determined by encoding a byte-count, word-count, or instruction count of each segment in the segment fields. In particular, the instruction header 910 can include segment fields 960, 970, and 980 to indicate the byte, word, or instruction counts of the segments 930, 940, and 950, respectively. If the ISA allows instructions of different sizes to occupy a particular segment, then byte or word counts may be desirable for encoding a corresponding segment field. However, if instructions of only a single size can occupy a particular segment, then instruction counts may be desirable for encoding a corresponding segment field. As one example, the segment field 960 can be encoded with the value 0x0030 to indicate that the segment 930 includes 48 bytes of instructions, with the value 0x000C to indicate that the segment 930 includes 12 words of instructions, or with the value 0x0006 to indicate that the segment 930 includes 6 instructions. As another example, the segment field 970 can be encoded with the value 0x0034 to indicate that the segment 940 includes 52 bytes of instructions, with the value 0x000D to indicate that the segment 940 includes 13 words of instructions, or with the value 0x000D to indicate that the segment 940 includes 13 instructions. Here, the number of words and the number of instructions are the same since the instructions have a single-word length. As another example, the segment field 980 can be encoded with the value 0x000C to indicate that the segment 950 includes 12 bytes of instructions, with the value 0x0003 to indicate that the segment 950 includes 3 words of instructions, or with the value 0x0004 to indicate that the segment 950 includes 4 instructions. In this example, the number of words are less than the number of instructions since the instructions have a sub-word length.

The starting position of a given segment can be determined from the segment fields by adding the size of any of the segments that precede the given segment to get the offset of the given segment. For example, the segment 930 has no segments preceding it so it starts at byte address 0x0000. The segment 940 is preceded by the segment 930, so the starting byte address of the segment 940 can be calculated by adding the size of the segment 930 to get the byte address 0x0030. The segment 950 is preceded by the segments 930 and 940, so the starting byte address of the segment 950 can be calculated by adding the size of the segments 930 and 940 to get the byte address 0x0064.

The segments 930, 940, 950 can be arranged in various orders. For example, the segments can be ordered so that the segments having larger-size instructions are before the segments having smaller-size instructions. As another example, the segments can be ordered so that the segments having instructions with lengths divisible by an alignment width are before the segments having instructions with lengths that are not divisible by the alignment width. As illustrated in FIG. 9, a segment consisting of double-word instructions precedes a segment consisting of single-word instructions, which precedes a segment consisting of sub-word instructions. Thus, aligning the starting positions of the segments on word boundaries can occur automatically since the earlier segments have instructions with lengths that are word-multiples (word and double-word) and the last segment is the only segment having instructions are not word-multiples (sub-word). Address calculations of subsequent segments may potentially be less complicated if the preceding segments consist of instructions of a size that match or are a multiple of an alignment width.

### X. Example Architectures for Fetch and Decode Logic

FIGS. 10-11 are examples of different configurations or architectures of fetch and decode logic of a block-based processor core. For example, the fetch and decode logic can be used within the processor core to perform parallel fetch and decode operations for different segments or sub-blocks of an instruction block. In some examples, the fetch and decode logic is implemented at least in part using one or more of: hardwired finite state machines, programmable microcode, programmable gate arrays, or other suitable control circuits. FIG. 10 is an example of fetch and decode logic that can be used to fetch and decode instruction blocks that are organized so that all instructions within a given sub-block are the same length (such as instruction block 900 of FIG. 9). FIG. 11 is an example of fetch and decode logic that can be used to fetch and decode instruction blocks that are organized so that the instructions within a given sub-block can be any length supported by the ISA (such as instruction block 800 of FIG. 8).

In FIG. 10, a processor core 1000 comprises a control unit 1010, an instruction cache 1020, and instruction decode logic 1030, 1040, and 1050. The control unit 1010 can include logic for sequencing the core 1000 through its various stages (such as described with reference to FIG. 6) of fetching, decoding, executing, and committing the instructions of an instruction block. For example, the control unit 1010 can include header decode logic 1012 for decoding fields of the instruction block header and fetch logic 1014 for initiating parallel fetch and decode operations instructions of the instruction block.

The instruction cache 1020 can be used for temporary storage of an instruction block that is to be executed by the processor core 1000. For example, the instruction cache 1020 can be loaded with the instruction block in response to the instruction block being allocated to the processor core 1000. The instruction block can be loaded from a second-level (L2) cache, main memory, or from secondary storage, for example. The instructions stored in the instruction cache 1020 can be read by other logic within the processor core 1000 using one or more read ports of the instruction cache 1020. Each read port can provide data stored at a read address provided to the instruction cache 1020. The instruction cache 1020 can be accessed at various granularities and can output data at various widths. For example, the instruction cache 1020 can be byte-addressable, word-addressable, or double-word-addressable. As another example, the instruction cache 1020 can output data that is 32-, 64-, 96-, 128-, 192-, or 256-bits wide. The read address can be changed each clock cycle. As illustrated, the instruction cache 1020 includes three read ports for outputting three 128-bit values in parallel during a single clock cycle.

The header decode logic 1012 can decode the instruction block header to determine starting positions of multiple sub-blocks within the instruction block. The ISA can specify how the starting position of each sub-block is determined In one embodiment, segment fields of the instruction header are used to encode an offset from the end of the instruction header or from the beginning of the previous segment using byte or word addresses. In another embodiment, segment fields of the instruction header are used to encode a byte-count, word-count, or instruction count of each sub-block corresponding to the segment field. The header decode logic 1012 can calculate the starting position of each sub-block by adding the size of any of the sub-blocks that precede the given sub-block to get the offset of the given sub-block. The offset of each sub-block can be used as the initial address for reading instructions of the respective sub-block from the instruction cache 1020.

The fetch logic 1014 can initiate parallel fetch and decode operations for the sub-blocks. Initially, the starting position (address) of each sub-block can be provided to respective read ports of the instruction cache 1020. As illustrated, three different addresses can be provided to the instruction cache 1020 so that instructions can be fetched in parallel for three different sub-blocks. In particular, a segment 0 address can be used to fetch 64-bit instructions, a segment 1 address can be used to fetch 32-bit instructions, and a segment 2 address can be used to fetch 24-bit instructions. The fetched instructions can be buffered by pipeline registers (not shown) and provided to the instruction decode logic 1030, 1040, and 1050.

In one embodiment, the instruction decode logic 1030, 1040, 1050 can be divided into different instruction decoders that are optimized for different width instructions. For example the instruction decoder 1030 can be used to only decode 64-bit instructions, the instruction decoder 1040 can be used to only decode 32-bit instructions, and the instruction decoder 1050 can be used to only decode 24-bit instructions. The decoders can potentially be made smaller and faster by specializing them for a single width of instruction. The instruction decode logic 1030, 1040, 1050 can operate in parallel so that a 64-bit instruction from segment 0, a 32-bit instruction from segment 1, and a 24-bit instruction from segment 2 can be decoded in parallel during the same cycle. The instruction decoders 1030, 1040, 1050 can transform the relatively compact machine code instructions to a less compact representation that can be used to control hardware resources of the processor core 1000 during execution of the instruction block. The decoded instructions can be buffered by pipeline registers (not shown) and provided to instruction windows of the processor core 1000 so that the instructions can be scheduled for execution. By fetching and decoding multiple instructions in parallel, the instruction block can potentially be executed faster since more instructions are made available for scheduling and execution. In other examples, the same decode logic is used to decode instructions having two or more different lengths. In some examples, reconfigurable logic is used to configure decode logic to be capable of decoding instructions having one or more different lengths.

In some examples, multiple instructions of a given sub-block can be fetched and decoded in parallel in a single cycle. For example, one or more of the optional decoders 1032, 1042, 1044, 1052, and 1054 can be used to decode instructions. In particular, the instruction decoder 1032 can be used to decode a second 64-bit instruction from segment 0; the instruction decoders 1042, 1044 can be used to decode additional 32-bit instructions from segment 1; and the instruction decoders 1052, 1054 can be used to decode additional 24-bit instructions from segment 2. There can be a trade-off between the number of instructions that are decoded in parallel and the amount of hardware resources used for decoding, routing, and storing the decoded instructions. In one embodiment, the number of decoders for each sub-block can be matched to the data-bus width of the instruction cache. For example, an ISA supporting 64-, 48-, 32-, and 24-bit instructions may divide the instructions into four sub-blocks and the core may include an instruction cache output bus of 192 bits, and three 64-bit instruction decoders, four 48-bit instruction decoders, six 32-bit instruction decoders, and eight 24-bit instruction decoders corresponding to the respective sub-blocks. As an example of a less hardware-intensive implementation, the core may include an instruction cache output bus of 96 bits, and one 64-bit instruction decoder, two 48-bit instruction decoders, three 32-bit instruction decoders, and four 24-bit instruction decoders corresponding to the respective sub-blocks. In this manner, different numbers of instructions can be decoded for different sub-blocks in a single clock cycle.

The instruction fetch logic 1014 can control the fetching of all of the instructions of the instruction block by sequencing through the addresses associated with each instruction. For example, the address associated with segment 0 can increase proportionally to a double-word for each 64-bit instruction that is decoded so that the next instruction in the sequence can be decoded, e.g., the address can increase by two for word addressing and by eight for byte addressing. Similarly, the address associated with segment 1 can increase proportionally to a word for each 32-bit instruction that is decoded and the address associated with segment 2 can increase proportionally to each 24-bit instruction that is decoded. In this manner, the fetch logic 1014 can sequence through all the addresses associated with all of the instructions of the instruction block. Thus, all instructions of all of the segments can be fetched and decoded by the fetch and decode logic of the processor core 1000.

FIG. 11 is an example of fetch and decode logic that can be used to fetch and decode instruction blocks that are organized so that the instructions within a given sub-block can be any length supported by the ISA (such as the instruction block 800 of FIG. 8). Thus, a given sub-block can include one or more of 24-, 32-, and 64-bit instructions, for example.

In FIG. 11, a processor core 1100 comprises a control unit 1110, an instruction cache 1120, instruction decode logic 1130, and multiplexor and routing logic 1160. The control unit 1110 can include logic for sequencing the core 1100 through its various stages of fetching, decoding, executing, and committing the instructions of an instruction block. For example, the control unit 1110 can include header decode logic 1112 for decoding fields of the instruction block header and fetch logic 1114 for initiating parallel fetch and decode operations instructions of the instruction block. The decoded instructions can be provided to the multiplexor and routing logic 1160 so that the decoded instructions can be stored in one or more instruction windows (not shown) of the processor core 1100. The instruction cache 1120 can include multiple read ports so that the instructions associated with different sub-blocks can be read out of the instruction cache 1120 in parallel.

The header decode logic 1112 can decode the instruction block header to determine starting positions of multiple sub-blocks within the instruction block. The ISA can specify how the starting position of each sub-block is determined. In one embodiment, segment fields of the instruction header are used to encode an offset from the end of the instruction header or from the beginning of the previous segment using byte or word addresses. In another embodiment, segment fields of the instruction header are used to encode a byte-count, word-count, or instruction count of each sub-block corresponding to the segment field. The header decode logic 1112 can calculate the starting position of each sub-block by adding the size of any of the sub-blocks that precede the given sub-block to get the offset of the given sub-block. The offset of each sub-block can be used as the initial address for reading instructions of the respective sub-block from the instruction cache 1120.

The fetch logic 1114 can initiate parallel fetch and decode operations for the sub-blocks. Initially, the starting position (address) of each sub-block can be provided to respective read ports of the instruction cache 1120. As illustrated, three different addresses can be provided to the instruction cache 1120 so that instructions can be fetched in parallel for three different sub-blocks. In particular, a segment 0 address can be used to fetch an instruction associated with segment 0, a segment 1 address can be used to fetch an instruction associated with segment 1, and a segment 2 address can be used to fetch an instruction associated with segment 2. In contrast to the fetch logic 1014 of FIG. 10, the length of the fetched instruction may not be known until the instruction is decoded. The fetched instructions associated with segment 0 can be buffered by pipeline registers (not shown) and provided to the instruction decode logic 1130. Similarly, fetched instructions associated with segments 1 and 2 can be buffered by pipeline registers (not shown) and provided to the instruction decode logic associated with segments 1 and 2 (not shown).

The instruction decode logic 1130 can distinguish between and decode instructions of different widths. In particular, the instruction decoder 1130 can determine a length or size of a particular instruction and can be used to decode 24-, 32-, and 64-bit instructions. The length information about the instruction can be provided to the fetch logic 1114 and/or the optional decoders 1132, 1140, 1142, 1150, and 1152. The optional decoders 1132, 1140, 1142, 1150, and 1152 can be used to decode multiple instructions of a given segment in parallel in a single cycle. As one example, the output from a read port of the instruction cache 1120 can be a 128 bit bus and the instruction decode logic 1130 can be connected to the lower 64 bits (e.g., bits 0-63) of the 128 bit bus and the instruction decode logic 1132 can be connected to the upper 64 bits (e.g., bits 64-127) of the 128 bit bus. Thus, two 64-bit instructions can be decoded for a given segment during the same clock cycle.

As another example, the output from the read port of the instruction cache 1120 can be a 128 bit data bus and the instruction decode logic 1130 can be connected to the lower 64 bits (e.g., bits 0-63) of the 128 bit bus and the instruction decode logic 1140 can be connected to the second word (e.g., bits 32-63) of the 128 bit bus. If the instruction decode logic 1130 determines the length of a particular instruction is 64-bits, then an output from the instruction decode logic 1140 is not used since there cannot be a 32-bit instruction overlapping a 64-bit instruction (instructions are sequential and not overlapping). Thus, the decoded length information from the instruction decode logic 1130 can be used to determine whether the output from the instruction decode logic 1140 is used. However, if the instruction decode logic 1130 determines that a valid 32-bit instruction is present at bits 0-31, then an output from the instruction decode logic 1140 may be used since there can be a sequential 32-bit instruction bits 32-63. Similarly, instruction decoders (such as decoders 1142, 1150, and 1152) can be arranged along the data bus to decode instructions that may follow a preceding instruction.

The instruction decode logic associated with the different segments can operate in parallel so that instructions from each of the segments can be decoded in parallel during the same cycle. The decoded instructions can be buffered by pipeline registers (not shown) and provided to instruction windows of the processor core 1100 via the multiplexor and routing logic 1160 so that the instructions can be scheduled for execution. The multiplexor and routing logic 1160 can be located prior to or after the pipeline registers.

The multiplexor and routing logic 1160 can be used to route the decoded instructions to write ports of the instruction windows. The number of outputs of the multiplexor and routing logic 1160 can be can be matched to the number of instructions that can be decoded in parallel during a single cycle. For example, if four instructions can be decoded in parallel (such as when there are four different instruction decoders) the multiplexor and routing logic 1160 can have four outputs. As a specific example, a 128-bit data bus from the instruction cache 1120 can be decoded into: two 64-instructions; four 32-bit instructions; one 64-bit instruction and two 32-bit instructions; five 24-bit instructions; one 64-instruction, one 32-bit instruction, and one 24-bit instruction; and so forth. The decoded length information from each instruction can be used to multiplex valid outputs from the decoders to the instruction windows.

The instruction fetch logic 1114 can control the fetching of all of the instructions of the instruction block by sequencing through the addresses associated with each instruction. The amount to increase the address during the next cycle can be based on the number and width of instructions that are decoded. Specifically, the address can be incremented proportionally to a sum of the lengths of the decoded instructions. For example, if a single instruction decoder (such as the instruction decoder 1130) is used, the address can be incremented by a double-word, a word, or a sub-word when the decoded instruction is a 64-, 32-, or 24-bit instruction, respectively. As another example, if a 24-bit instruction and 32-bit instruction are decoded in the same cycle, the byte-address can increase by seven to account for the seven bytes of instructions that are decoded. In this manner, the fetch logic 1114 can sequence through all the addresses associated with all of the instructions of the instruction block. Thus, all instructions of all of the segments can be fetched and decoded by the fetch and decode logic of the processor core 1100.

### XI. Example Methods of Fetching and Decoding Instructions

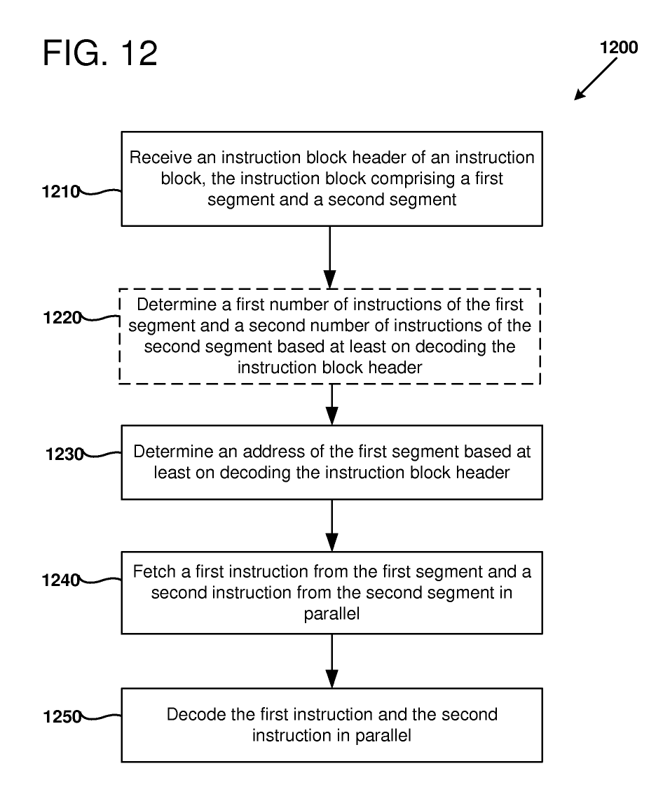

FIG. 12 is a flowchart illustrating is an example method 1200 of fetching and decoding instructions in a block-based processor core. For example, the method 1200 can be performed using instructions generated with a compiler that organizes the instructions of respective instruction blocks by segments. The compiler can be executed on the same block-based processor core executing method 1200, or the compiler can be executed on a different computer. The method 1200 can be used to fetch and decode the instructions of the different segments in parallel. Thus, the method 1200 may potentially increase the execution speed of the processor core since a greater number of instructions may be scheduled for execution sooner than if the instructions were not organized into segments.

At process block 1210, an instruction block header of an instruction block is received. For example, the instruction block header can be received by instruction header decode logic when the instruction block is allocated to the processor core. The instruction block can include a first segment and a second segment, where each of the first and second segments include one or more instructions. Different ISAs may support different types of segments. In one embodiment, each of the one or more instructions of the first segment can have a first length (such as 64-bits) and each of the one or more instructions of the second segment can have a second length (such as 32-bits), where the second length is different from the first length. In another embodiment, each of the one or more instructions of the first segment can have different lengths and each of the one or more instructions of the second segment can have different lengths. The first segment and the second segment can have a predefined number of instructions, such as eight instructions per segment. In other words, the instructions can be packed into the segments so that all but the last segment have the same number of instructions, and a number of instructions for the last segment is the total instructions of the instruction block modulo the predefined number of instructions. The number of segments can vary depending on the number of instructions of the instruction block, so the last segment can be the highest numbered segment with instructions to execute.

At process block 1220, a first number of instructions of the first segment and a second number of instructions of the second segment can be optionally determined based at least on decoding the instruction block header. For example, respective segment fields of the instruction block header can be used encode a value indicating the number of instructions of a corresponding segment. By decoding the segment fields, the number of instructions of each segment can be determined. Alternatively, the first number of instructions of the first segment and the second number of instructions of the second segment can be determined without decoding the instruction block header. For example, the first number of instructions and the second number of instructions can be the predefined number of instructions of a segment.

At process block 1230, an address of the first segment can be determined based at least on decoding the instruction block header. As example, a respective segment field of the instruction block header can be used to encode an offset associated with the initial instruction of the first segment. The offset may be relative to the end of the instruction block header or relative to another segment. The offset can be indicated using various granularities, such as a number bytes, words, double-words, or instructions, for example. The address of the first segment can be the decoded value of the segment field, such as when the segment field includes an offset relative to the end of the instruction block header. The address of the first segment can be calculated by adding the offsets of preceding segments that are encoded in their respective segment fields. As another example, segment fields of the instruction block header can indicate sizes of the respective segments, and the segments can be ordered according to a size of the instructions of the segments. Thus one ordering can be from largest instructions to smallest instructions, so that 64-bit instructions are in segment 0 (directly after the instruction header), 32-bit instructions are in segment 1 (directly following segment 0), and 24-bit instructions are in segment 2 (directly following segment 1). The address of segment 0 can be calculated as 0x0000; the address of segment 1 can be calculated as the size of segment 0; and the address of segment 2 can be calculated as the size of segment 0 added to the size of segment 1.

At process block 1240, a first instruction can be fetched from the first segment and a second instruction can be fetched from the second segment. The instructions can be fetched in parallel (e.g., during the same clock cycle). For example, a first read address associated with the first instruction and a second read address associated with the second instruction can be provided to an instruction cache of the block-based processor core. Specifically, the different read addresses can be provided to different ports of the instruction cache so that the instruction cache can output the first instruction and the second instruction on different respective output data busses.

At process block 1250, the first instruction and the second instruction can be decoded in parallel (e.g., during the same clock cycle). For example, a first instruction decoder for decoding the first instruction can be in communication with a first output port of the instruction cache and a second instruction decoder for decoding the second instruction can be in communication with a second output port of the instruction cache. Decoding the instructions can include determining lengths of the respective instructions. The lengths of the respective instructions can be used to identify subsequent instructions within the segment. The subsequent instructions can be decoded in the same clock cycle or in subsequent clock cycles. As a specific example, the length of the first instruction can be used to identify a third instruction within the same segment. In one embodiment, the third instruction can be decoded using a third instruction decoder in parallel with the first instruction decoder, so that the first and third instructions can be decoded in the same cycle. In an alternative embodiment, the length of the first instruction can be used to calculate the address of the third instruction so that the third instruction can be fetched, and then decoded in a subsequent cycle by the first instruction decoder. In this manner, all of the instructions of each segment can be fetched and decoded so that the instructions of the instruction block can be executed on the block-based processor core.

### XII. Example Computing Environment

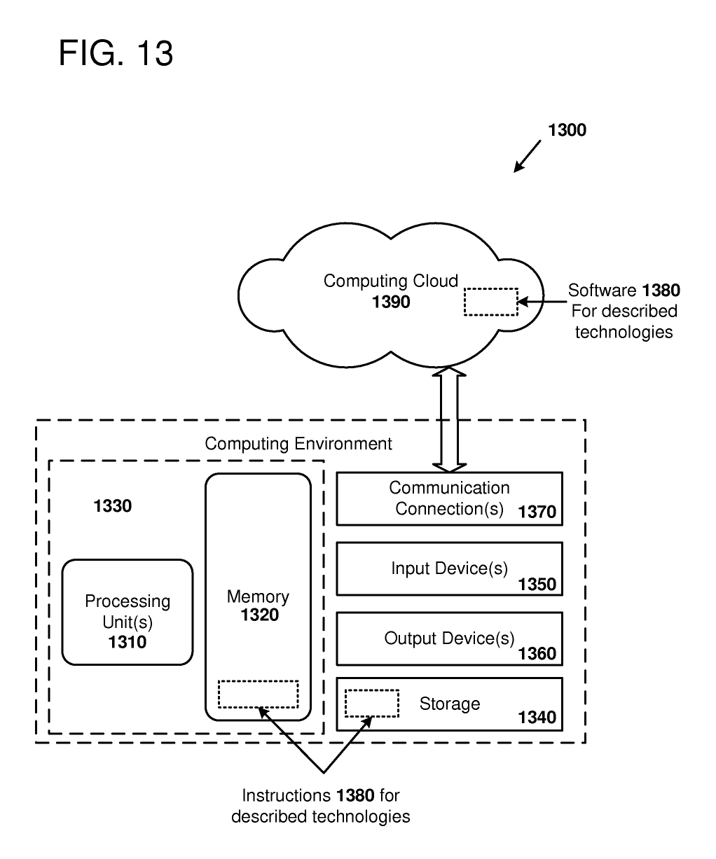

FIG. 13 illustrates a generalized example of a suitable computing environment 1300 in which described embodiments, techniques, and technologies, including compiling a segmented instruction block for a block-based processor, can be implemented. For example, the computing environment 1300 can implement disclosed techniques for compiling, fetching, and decoding instructions, as described herein.

The computing environment 1300 is not intended to suggest any limitation as to scope of use or functionality of the technology, as the technology may be implemented in diverse general-purpose or special-purpose computing environments. For example, the disclosed technology may be implemented with other computer system configurations, including hand held devices, multi-processor systems, programmable consumer electronics, network PCs, minicomputers, mainframe computers, and the like. The disclosed technology may also be practiced in distributed computing environments where tasks are performed by remote processing devices that are linked through a communications network. In a distributed computing environment, program modules (including executable instructions for block-based instruction blocks) may be located in both local and remote memory storage devices.

With reference to FIG. 13, the computing environment 1300 includes at least one block-based processing unit 1310 and memory 1320. In FIG. 13, this most basic configuration 1330 is included within a dashed line. The block-based processing unit 1310 executes computer-executable instructions and may be a real or a virtual processor. In a multi-processing system, multiple processing units execute computer-executable instructions to increase processing power and as such, multiple processors can be running simultaneously. The memory 1320 may be volatile memory (e.g., registers, cache, RAM), non-volatile memory (e.g., ROM, EEPROM, flash memory, etc.), or some combination of the two. The memory 1320 stores software 1380, images, and video that can, for example, implement the technologies described herein. A computing environment may have additional features. For example, the computing environment 1300 includes storage 1340, one or more input devices 1350, one or more output devices 1360, and one or more communication connections 1370. An interconnection mechanism (not shown) such as a bus, a controller, or a network, interconnects the components of the computing environment 1300. Typically, operating system software (not shown) provides an operating environment for other software executing in the computing environment 1300, and coordinates activities of the components of the computing environment 1300.

The storage 1340 may be removable or non-removable, and includes magnetic disks, magnetic tapes or cassettes, CD-ROMs, CD-RWs, DVDs, or any other medium which can be used to store information and that can be accessed within the computing environment 1300. The storage 1340 stores instructions for the software 1380, plugin data, and messages, which can be used to implement technologies described herein.

The input device(s) 1350 may be a touch input device, such as a keyboard, keypad, mouse, touch screen display, pen, or trackball, a voice input device, a scanning device, or another device, that provides input to the computing environment 1300. For audio, the input device(s) 1350 may be a sound card or similar device that accepts audio input in analog or digital form, or a CD-ROM reader that provides audio samples to the computing environment 1300. The output device(s) 1360 may be a display, printer, speaker, CD-writer, or another device that provides output from the computing environment 1300.

The communication connection(s) 1370 enable communication over a communication medium (e.g., a connecting network) to another computing entity. The communication medium conveys information such as computer-executable instructions, compressed graphics information, video, or other data in a modulated data signal. The communication connection(s) 1370 are not limited to wired connections (e.g., megabit or gigabit Ethernet, Infiniband, Fibre Channel over electrical or fiber optic connections) but also include wireless technologies (e.g., RF connections via Bluetooth, WiFi (IEEE 802.11a/b/n), WiMax, cellular, satellite, laser, infrared) and other suitable communication connections for providing a network connection for the disclosed agents, bridges, and agent data consumers. In a virtual host environment, the communication(s) connections can be a virtualized network connection provided by the virtual host.

Some embodiments of the disclosed methods can be performed using computer-executable instructions implementing all or a portion of the disclosed technology in a computing cloud 1390. For example, disclosed compilers and/or block-based-processor servers are located in the computing environment 1330, or the disclosed compilers can be executed on servers located in the computing cloud 1390. In some examples, the disclosed compilers execute on traditional central processing units (e.g., RISC or CISC processors).

Computer-readable media are any available media that can be accessed within a computing environment 1300. By way of example, and not limitation, with the computing environment 1300, computer-readable media include memory 1320 and/or storage 1340. As should be readily understood, the term computer-readable storage media includes the media for data storage such as memory 1320 and storage 1340, and not transmission media such as modulated data signals.

### XIII. Additional Examples of the Disclosed Technology

Additional examples of the disclosed subject matter are discussed herein in accordance with the examples discussed above.

In one embodiment, a processor includes a block-based processor core that can be used for executing an instruction block. The instruction block includes an instruction header and one or more instructions, where the instructions are arranged within a plurality of sub-blocks of the instruction block. The particular arrangement of the instruction block can be specified by an ISA of the block-based processor. Different instructions can have different lengths. The block-based processor core includes header decode logic and fetch logic that are in communication with each other. The header decode logic is configured to decode the instruction block header to determine designated starting positions of the plurality of sub-blocks. The fetch logic is configured to initiate parallel fetch and decode operations for a plurality of instructions of one or more of the plurality of sub-blocks.

In one arrangement of the instruction block, all instructions within a given sub-block of the plurality of sub-blocks are the same length. The number of instructions within respective sub-blocks of the one or more sub-blocks can be different. The block-based processor core can include instruction decode logic configured to decode instructions of the plurality of sub-blocks. During a given clock cycle, a first number of instructions can be decoded for a first sub-block of the plurality of sub-blocks, and a second number of instructions can be decoded for a second sub-block of the plurality of sub-blocks, where the first number is different from the second number.

In another arrangement of the instruction block, a given sub-block of the plurality of sub-blocks can include instructions of different lengths. The plurality of sub-blocks of the instruction block can be packed to have a maximum predefined number of instructions. Thus, none of the plurality of sub-blocks of the instruction block can have more than a maximum number of instructions, where the maximum number of instructions is predefined by an instruction set architecture of the block-based processor core. The block-based processor core can include instruction decode logic configured to determine a fetch address corresponding to a starting position of a next instruction of the given sub-block.

The block-based processor can be used in a variety of different computing systems. For example, a server computer can include non-volatile memory and/or storage devices; a network connection; memory storing one or more segmented instruction blocks; and the block-based processor for executing segmented instruction blocks. As another example, a device can include a user-interface component; non-volatile memory and/or storage devices; a cellular and/or network connection; memory storing one or more segmented instruction blocks; and the block-based processor for executing segmented instruction blocks. The user-interface component can include at least one or more of the following: a display, a touchscreen display, a haptic input/output device, a motion sensing input device, and/or a voice input device.

In one embodiment, a method of fetching and decoding instructions in a block-based processor core includes receiving an instruction block header of an instruction block. The instruction block includes a first segment and a second segment, where each of the first and second segments includes one or more instructions. The instruction block can include instructions of different lengths. The method includes determining an address of the first segment based at least on decoding the instruction block header. The method includes fetching a first instruction from the first segment and a second instruction from the second segment in parallel. The method includes decoding the first instruction and the second instruction in parallel. Fetching the first instruction and the second instruction can include providing a first read address associated with the first instruction and a second read address associated with the second instruction to an instruction cache of the block-based processor core. Decoding the first instruction can include determining a first length of the first instruction and decoding the second instruction can include determining a second length of the second instruction. Decoding the first instruction and the second instruction can include determining an address of a third instruction based on a length of the first instruction and determining an address of a fourth instruction based on a length of the second instruction. Each of the one or more instructions of the first segment can have a first length, and each of the one or more instructions of the second segment can have a second length that is different from the first length. The method can include determining a first number of instructions of the first segment and a second number of instructions of the second segment based at least on decoding the instruction block header. Alternatively, the first segment and the second segment have a predefined number of instructions, where the predefined number is specified by an instruction set architecture of the block-based processor core.

In one embodiment, one or more computer-readable storage media store computer-readable instructions that when executed by a computer cause the computer to perform a method. The instructions include instructions to cause the computer to group instructions into a plurality of instruction blocks targeted for execution on a block-based processor. The instructions include instructions to cause the computer to group instructions of a respective instruction block into a plurality of segments of the respective instruction block. The instructions include instructions to cause the computer to generate an instruction block header for the respective instruction block. The header includes information for determining a starting position of a segment of the plurality of segments. The instructions include instructions to cause the computer to emit the plurality of instruction blocks for execution by the block-based processor in a computer-readable memory or storage device. The instructions may further include instructions to store the emitted plurality of instruction blocks in one or more computer-readable storage media or devices. All instructions of a respective segment of a respective instruction block may be uniform length. Grouping instructions of a respective instruction block into a plurality of segments may include packing respective segments with a predefined number of instructions. The information for determining the starting position of the segment of the plurality of segments can be an offset relative to a location of the instruction block. The information for determining the starting position of the segment of the plurality of segments can be a size of a different segment of the plurality of segments.

In view of the many possible embodiments to which the principles of the disclosed subject matter may be applied, it should be recognized that the illustrated embodiments are only preferred examples and should not be taken as limiting the scope of the claims to those preferred examples. Rather, the scope of the claimed subject matter is defined by the following claims. We therefore claim as our invention all that comes within the scope of these claims.

We claim:

1. A processor comprising a block-based processor core for executing an instruction block comprising an instruction header and one or more instructions, the block-based processor core comprising:
header decode logic configured to decode the instruction block header to determine designated starting positions of a plurality of sub-blocks within the instruction block; and
fetch logic in communication with the header decode logic, the fetch logic configured to initiate parallel fetch and decode operations for a plurality of instructions of one or more of the plurality of sub-blocks.

2. The block-based processor core of claim 1, wherein the instruction block comprises instructions having two or more different lengths, and wherein all instructions within a given sub-block of the plurality of sub-blocks have the same length.

3. The block-based processor core of claim 2, further comprising:
instruction decode logic configured to decode the instructions of the plurality of sub-blocks, and wherein during a given clock cycle, a first number of instructions are decoded for a first sub-block of the plurality of sub-blocks, and a second number of instructions are decoded for a second sub-block of the plurality of sub-blocks, the first number being different from the second number.

4. The block-based processor core of claim 1, wherein the instruction block comprises instructions of different lengths, and a given sub-block of the plurality of sub-blocks comprises instructions having two or more different lengths.

5. The block-based processor core of claim 4, further comprising:
instruction decode logic configured to determine a fetch address corresponding to a starting position of a next instruction of the given sub-block.

6. The block-based processor core of claim 1, wherein respective sub-blocks of the one or more sub-blocks have different numbers of instructions.

7. The block-based processor core of claim 1, wherein none of the plurality of sub-blocks of the instruction block have more than a maximum number of instructions, the maximum number of instructions predefined by an instruction set architecture of the block-based processor core.

8. A method of fetching and decoding instructions with a block-based processor core, the method comprising:
receiving an instruction block header of an instruction block, the instruction block comprising a first segment and a second segment, each of the first and second segments comprising one or more instructions;
determining an address of the first segment based at least on decoding the instruction block header;
fetching a first instruction from the first segment and a second instruction from the second segment in parallel; and
decoding the first instruction and the second instruction in parallel.

9. The method of claim 8, wherein each of the one or more instructions of the first segment has a first length, and each of the one or more instructions of the second segment has a second length that is different from the first length.

10. The method of claim 8, wherein fetching the first instruction and the second instruction comprises providing a first read address associated with the first instruction and a second read address associated with the second instruction to an instruction cache of the block-based processor core.

11. The method of claim 8, wherein the instruction block comprises instructions of different lengths, and decoding the first instruction comprises determining a first length of the first instruction and decoding the second instruction comprises determining a second length of the second instruction.

12. The method of claim 8, wherein the instruction block comprises instructions of different lengths, and decoding the first instruction and the second instruction comprises determining an address of a third instruction based on a length of the first instruction and determining an address of a fourth instruction based on a length of the second instruction.

13. The method of claim 8, further comprising:
determining a first number of instructions of the first segment and a second number of instructions of the second segment based at least on decoding the instruction block header.

14. The method of claim 8, wherein the first segment and the second segment have a predefined number of instructions, the predefined number specified by an instruction set architecture of the block-based processor core.

15. One or more computer-readable storage media storing computer-readable instructions that when executed by a computer cause the computer to perform a method, the instructions comprising:
instructions to cause the computer to group instructions into a plurality of instruction blocks targeted for execution on a block-based processor;
instructions to cause the computer to group instructions of a respective instruction block into a plurality of segments of the respective instruction block;
instructions to cause the computer to generate an instruction block header for the respective instruction block, the header comprising information for determining a starting position of a segment of the plurality of segments; and
instructions to cause the computer to emit the plurality of instruction blocks for execution by the block-based processor in a computer-readable memory or storage device.

16. The computer-readable storage media of claim 15, wherein all instructions of a respective segment of a respective instruction block are a uniform length.

17. The computer-readable storage media of claim 15, wherein grouping instructions of a respective instruction block into a plurality of segments comprises packing respective segments with a predefined number of instructions.

18. The computer-readable storage media of claim 15, wherein the information for determining the starting position of the segment of the plurality of segments is an offset relative to a location of the instruction block.

19. The computer-readable storage media of claim 15, wherein the information for determining the starting position of the segment of the plurality of segments is a size of a different segment of the plurality of segments.

20. The computer-readable storage media of claim 15, wherein the instructions further comprise instructions to store the emitted plurality of instruction blocks in one or more computer-readable storage media or devices.
